(19) United States
(12) Patent Application Publication
(10) Pub. No.: US 2012/0308970 A1
(43) Pub. Date: Dec. 6, 2012

(54) APPARATUS AND METHODS FOR PROMOTING BEHAVIORAL CHANGE IN HUMANS

(76) Inventors: Penny D. Gillespie, Centreville, VA (US); Connie Moore Behan, Waterford, VA (US)

(21) Appl. No.: 13/427,863

(22) Filed: Mar. 22, 2012

Related U.S. Application Data
(60) Provisional application No. 61/466,361, filed on Mar. 22, 2011.

(51) Int. Cl. G09B 19/00; G06F 15/16

(52) U.S. Cl. 434/236

(57) ABSTRACT

Apparatus and methods for providing a comprehensive system for human behavior modification are disclosed. The apparatus and methods employ networking allowing user devices, and primarily to allow communication with a first user device having one more applications or functions to assist a targeted user, such as a child, to promote human behavior modification in that user. Additionally, a second user device may be connected to the network that further provides communication and functionalities for a second, assisting user, such as a parent, to assist and motivate the targeted user via the first user device in human behavior modification. The system provides multiple functions or applications to engender cause and effect motivation, reward motivation, personal management, and visualization to effect behavioral changes in the targeted user with assistance from the assisting users, as well as social networking and collaborative networking.

### CLAIM OF PRIORITY UNDER 35 U.S.C. §119

The present Application for Patent claims priority to Provisional Application No. 61/466,361 entitled “APPARATUS AND METHODS FOR PROMOTING BEHAVIORAL CHANGE IN HUMANS” filed Mar. 22, 2011, and is hereby expressly incorporated by reference herein.

### BACKGROUND

1. Field

The present disclosure relates generally to apparatus and methods for promoting human behavior changes, and more specifically to apparatus and methods that utilize computer applications and networks to provide educational, networking and behavior modification functionalities and applications in an integrated system for human education, development, and behavior modification that may be used, in particular, by and for children and their parents or guardians.

2. Background

Systems and methodologies for effecting positive changes in human behavior to develop individuals, particularly for children, adolescents and young adults, are numerous. However, solutions to effect changes in certain behaviors, educate and inform, and promote personal development are varied, fragmented and typically only target one or a few behaviors. For example, various and disjointed solutions are available in behavior rewards, scheduling, task and project management, goal-setting, social skills, values development, and weight management. Such solutions tend to be so numerous, disjointed, and varied that their use becomes overwhelming and unwieldy for helping behavior development across a numerous areas of human behavior, thus failing to provide integrated, comprehensive and/or holistic solutions. For example, known applications such as iChores, iHomework, iStudiez Pro, Kids Paid, and myHomework offer only limited and targeted functionality, and have no interface or shared overarching functionality.

Solutions to child and adolescent behavior modification become further complicated with individuals having developmental issues or conditions such as Attention deficit hyperactivity disorder (ADHD/ADD), Autism, dyslexia, bipolar disorder, blindness, etc. Furthermore, although there is increasing awareness concerning the rise of childhood obesity and eating/diet issues, little or no solutions utilizing technology and incentives exist to help address such issues. Additionally, extensive professional help can put economic pressures and burdens on families, limiting parents' or assisting users' ability to gain help for their children with schoolwork, social skills, psychological needs, tutoring, nutrition, financial management, and other services for children, adolescents, and young adults who need additional help.

There is therefore a need in the art for a comprehensive or holistic solution for providing various solutions and methodologies to effect behavior modification and development in humans, particularly for children, adolescents, and young adults, as well as to their parents or guardians (and other care providers such as teachers, physicians, etc.) trying to assist in this endeavor. Additionally, there is a need in the art to provide such a solution through lower cost means and with high connectivity including mobile connectivity and networking. Additionally, a need exists for solution that providing incentives and rewards, as well as entertainment and visualization to increase the likelihood that users of the solution will continue use to ensure results. Yet further, a need exists to provide a comprehensive solution that also may be used effectively for helping individuals having developmental issues or conditions or body weight/eating issues.

### SUMMARY

According to an aspect, an apparatus for providing human behavior modification solutions to user is disclosed. The apparatus includes a network allowing one or more user devices to communicate and provide functionalities to the one or more user devices. Additionally, the apparatus includes at least one first user device configured to connect to a network, the user device configured to include one or more applications or functions configured to assist at least a first targeted user using the at least one first user device for human behavior modification. In a further aspect, the apparatus may further include at least one second user device configured to connect to the network, the at least one second user device configured to include one or more applications or functions configured to at least provide at least a second assisting user functionality to provide assistance to the at least a first targeted user using the at least one first user device in human behavior modification.

According to another aspect, a computer program product comprising computer-readable medium is disclosed. The medium includes code for causing a computer to implement a network allowing user devices to communicate and provide functionalities to the user devices. The medium also includes code for causing a computer to provide at least one first user device a functionality to connect to the network and one or more applications or functions configured to assist at least a first targeted user using the at least one first user device in human behavior modification. In a further aspect, the computer-readable medium may also include code for causing a computer to provide at least one second user device a functionality to connect to the network, and one or more applications or functions configured to at least provide a second assisting user functionality to provide assistance to the first targeted user using the at least one first user device in human behavior modification.

In still another aspect, a method for providing human behavior modification solutions to a user in a system of behavior modification is disclosed. The method includes providing a network allowing user devices to communicate and provide functionalities to the user devices. Additionally, the method includes providing functionality to at least a first user device including functionality to connect to the network, the first user device configured to include one or more applications or functions configured to assist a first targeted user using the at least one first user device in human behavior modification. In a further aspect, the method may also include providing at least one second user device with functionality to connect to the network, the at least one second user device configured to include one or more applications configured to at least provide a second assisting user functionality to provide assistance to at least a first targeted user using the at least a first user device in human behavior modification.

### BRIEF DESCRIPTION OF THE DRAWINGS

FIG. 1 is a diagram of an exemplary system architecture of a system for promoting behavior modification using a network.

FIG. 2 is a diagram illustrating an exemplary hierarchy of the disclosed system for promoting behavior modification.

FIG. 3 is an exemplary screen representation for displaying a targeted user's success or reward progression over a time frame.

FIG. 4 illustrates exemplary screen layouts of lists displayed to a targeted user in the disclosed system.

FIG. 5 illustrates an exemplary screen layout of an assisting user's view of a targeted user's “To Do” list.

FIG. 6 illustrates an exemplary screen layout of an assisting user's view of a targeted user's “Get it Done!” list.

FIG. 7 an exemplary screen layout of an assisting user's view of a targeted user's “To Prep” list.

FIG. 8 illustrates an exemplary view of communication messages that are displayed to targeted and assisting users.

FIG. 9 shows an exemplary screen display for a targeted user.

FIG. 10 shows a calendar illustrating the amount of time committed and the amount of time available to the targeted user that may be displayed to users of the disclosed system.

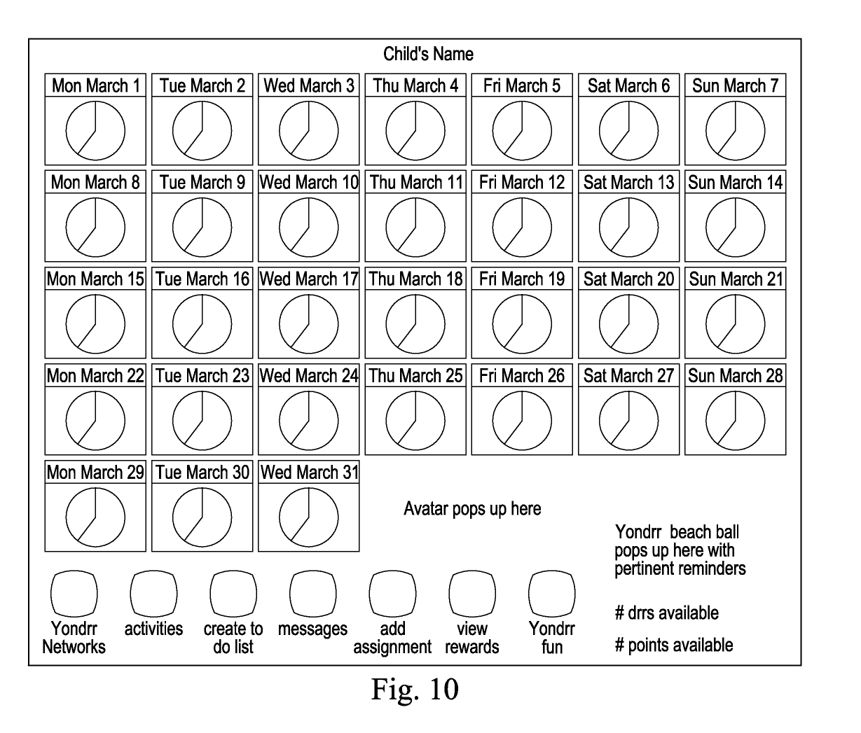

FIG. 11 illustrates an exemplary screen view of a targeted user's calendar displayed to an assisting user.

FIG. 12 shows an exemplary screen for activity view to a targeted user and the functionality for entering activities.

FIG. 13 shows an exemplary screen for an assisting user's activity view to a targeted user and the functionality for entering activities.

FIG. 14 illustrates an exemplary screen for project planning by a targeted user.

FIG. 15 illustrates an exemplary system screen for opening the assisting user's reward system.

FIG. 16 illustrates an exemplary screen for setting or viewing system credit rewards by an assisting user for various goals or tasks completed by the targeted user.

FIG. 17 illustrates an exemplary screen for setting or viewing system points rewards by an assisting user for various behavioral goals to be completed by the targeted user.

FIG. 18 illustrates an exemplary screen for setting system credit rewards by an assisting user for various behavioral goals to be completed by the targeted user.

FIG. 19 illustrates an exemplary screen for setting system credit rewards by an assisting user for various goals or tasks completed by the targeted user.

FIG. 20 illustrates an exemplary motivation questionnaire screen that may be used for assisting the assisting user in setting up rewards through a series of questions and selections.

FIG. 21 illustrates an exemplary screen illustrating an exemplary health management application for targeted users of the system.

FIG. 22 is a diagram of an apparatus for implementing a system for promoting behavior modification.

FIG. 23 illustrates an exemplary system screen allowing a user to select and enter types of tasks and supplies needed for an assignment or assigned task.

FIG. 24 illustrates an exemplary system screen affording entry of assignments by a user.

### DETAILED DESCRIPTION

In order to solve the needs presented above, the present apparatus and methods provide a networked system of applications, functionalities and tools to provide behavioral modification resources to at least a first “targeted user”, which is term herein to denote a child or adolescent or any other individual user being assisted or helped with the disclosed system, as well as provide social networking and collaboration networking (hereinafter collectively referred herein to as the “system”) to those users. Furthermore, the methods and apparatus allow one or more second “assisting users,” which is a term to denote primarily parents and/or legal guardians, but is not limited to such and could also include teachers, health care professionals, etc., to monitor the targeted users, provide rewards to the targeted users, as well as social and resources networking with other similar users. It is noted that the assisting users may not need include a parent or guardian, such as in situations where the targeted user may not have proper mentoring in their home environment.

According to a further aspect, the system provides applications or protocols that afford a rich, imaginative, and visual social space that also provides rewards to targeted users for positive behavior, supports interactivity between children and parents about school, sports and social life, offers rich virtual communities of interest for parents about any topic they care to launch (e.g., bullying, obesity, physical fitness, advanced placement programs, helping kids with Asperger's, ADHD/ADD, dyslexia, bipolar, blindness and so forth). Moreover, the present system provides a rich, visual, social world for users (e.g., targeted users) to collaborate on projects such as creating and sharing art, poems, short stories, videos, science projects and other personal and team projects.

The presently disclosed apparatus and methods provide, in one example, applications that are configured to run on computers, smart devices, mobile devices, and similar computing device using one or more of rewards, serious gaming techniques, information and visualization for scheduling and management, and cause and effect information and visualization to teach academic, executive function, and social skills for lasting behavior change. The goal is to migrate a targeted user from extrinsic rewards to intrinsic rewards for their actions.

It is further noted that at least only a portion of the presently disclosed apparatus and methods may be employed such that a targeted user does not include a connection with a second assisting user if an assisting user is not available. Instead, the targeted user is only connected to the disclosed system and utilizes those functions, as discussed in the following description, that do not require an assisting user or some other human input. Thus, the system and/or sundry system functionalities directed toward behavior modification become a proxy or substitute for a real human assisting user. Accordingly, although the following description includes both functions for targeted and assisting users working in conjunction, the present disclosure is not limited to such and may include only a targeted user connected to a network and using applications or functions that only need one targeted user input to function, which may include social and creative networking with other targeted users of the system, and receiving systems rewards to motivate behavioral changes

In another aspect, the system provides a social, creativity network configured to allow targeted users to connect with one another for collaboration, to foster creativity, build self-confidence and boost self-esteem. In still another aspect, the system also provides a social network allowing assisting users, such as assisting users, to be put in touch with other like users as well as in touch with other users such as experts that can assist assisting users in solving their targeted users' issues.

The present apparatus and methods (also collectively referred to herein as the “system”) may be implemented by a system or application that allows a targeted user, such as a student, to enter their school workload and share it with one or more assisting users (e.g., their parents). In addition to the schedule information, students can also share various interests and are rewarded for good behavior. The system affords the assisting user to see the targeted user's workload, and send information to the targeted user. In addition, the system may be configured to notify both the targeted user and the assisting user(s) about the status of each assignment or task assigned to the targeted user. The assisting user may be able to access this information either via their mobile device or online via a web browser. In yet another aspect, the system may include a health management application for targeted users that also may use one or more of rewards, serious gaming techniques, visualization, and cause and effect to teach healthy living through fitness, nutrition and weight management.

The system may be configured to be a visual and artistic software application for assisting users and targeted users that runs on computers, and mobile devices such as smartphones and tablets, and operates on client/servers and web servers on the backend to provide synchronization between devices.

Moreover, it is noted that social networking has become commonplace and widespread for parents and kids. The presently disclosed methods and apparatus therefore build upon the concepts of social media as a tool allowing assisting users (i.e., parents) to interact with the targeted users (i.e., their children), parents to share ideas with other parents, children to socialize and collaborate with other kids. As an interface to the present system/network, the system may utilize computer and mobile computing devices, such as smartphones, tablet devices, netbooks, laptops, and other portable devices such as MP3 or AAC devices, and portable gaming systems to provide connectivity and mobility allowing interact among peer groups close to or far from home via anyone of various networking technologies (e.g., WiFi, WiMax, 3G networks, 4G networks, cellular networks, internet, etc.).

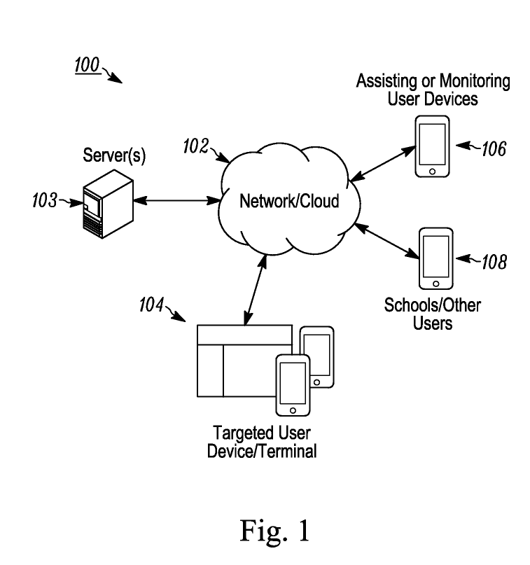

In an aspect, the disclosed system may utilize a client-server model, but the architecture is not necessarily limited to such and may employ other cloud computing architectures. As an illustration, FIG. 1 illustrates an exemplary system 100 that may include a network or cloud 102 that provides connectivity among numerous user devices. The network 102 may be configured to synchronize and connect devices (and thus users) that are part of the system 100. Additionally, the network 102 may be configured to host different functions and services, such as social networking for targeted and assisting users, creativity or collaborative networking allowing users to share and collaborate on subject matter, and effect network security and backups. A server or servers 103 shown in FIG. 1 may be employed at a central location or at diffuse locations to administer all shared data within the system 100. Any client/users requests for shared data may be requests to the server 103, and replies of data delivered therefrom.

System 100 also includes targeted user devices 104 used by targeted user clients, and these devices may include devices such as mobile smartphone devices or computers. The functionalities afforded devices 104 through a software application stored therein are interfacing with the network 104 include entry of user information, displaying and maintaining scheduling information and task, receiving information from system processing running on the network 102 and/or server 103 or other users, display and receipt of rewards (to be discussed later), share and collaborate with other users on projects or Creativity works, as well as networking/connecting with other users of the system including other targeted users, assisting users, or other users such as school officials.

A website may be also part of the system 100 on servers 103 and may be accessed by the users/clients via a web browser such as Internet Explorer, Mozilla Firefox, Google Chrome, or any other network browser. Similar to many other websites, the client browser will make a request to the web server based on the code with which the server last responded in conjunction with the user's action. This cycle repeats until the user breaks the cycle and stops acting with the site.

Server 103 may include a web server that is a program or function that listens for clients to request resources and serves the resource back to the client. When the server 103 receives a request from the client browser, server 103 will process the request. If the client/user requests a static resource, it will be delivered. However, if the client requests dynamic content, such as a targeted user's scheduling information, the server will gather the appropriate data from the database that resides local to the server. The web server and the client/user may communicate via Hyper Text Transfer Protocol (HTTP). HTTP allows the client/user browser to request the resources from the web server that it needs to display the website. HTTP also allows the server to provide responses to every resource requested, for example, if the resource could not be found. The web server's primary goal is to enforce the business rules and logic by processing the resources requested. The resources are processed within the web application, which implements the business rules and logic. The web application assumes that an attempt to access data illegitimately could occur at any point in the system, a web application (the code that the server runs to enforce the business logic) is typically written to protect the data it allows others to access. The web application protects the data by being the only interface to the database, this makes the web application the last line of defense against intrusion.

In an aspect, a database (not shown) connected with the server 103 will not be public facing, meaning it will not be directly accessible by any client nor is it considered to be “in the cloud” (a term referring to a resource which is directly accessible over the interna). All requests for data will need to go through the web application, thus going through the web application's processes; applying the business rules of the application to gather the data requested while protecting the data that the business rules indicate should not be shared. If desired, the database could reside on multiple physical machines to provide service redundancy in case of an outage or just a single machine if traffic is low (even the same one as the web server program).

Additionally, system 100 also features assisting user devices 106 such as mobile smartphone devices or computers for assisting users, such as parents, that may have different functionalities from the devices 104 for targeted users. Examples of functionalities include tracking of associated targeted user's schedules, calendar, tasks, affording functions for rewards to be awarded to associated targeted users, as well as connectivity/networking with other assisting users or school officials, as well as with associated targeted users. These will be discussed in more detail later.

Further, system 100 may include connectivity of other users' devices 108 that could be used by school officials, such as teachers and other educators, or other users such as outside entities (e.g., learning companies, exercise/fitness companies, dieticians/weight management companies, healthcare and mental health professionals, or any other educational/health/personal development type entities). In one embodiment, educator users could incorporate the network connectivity of the system 100 for special programs such as Individualized Education Programs (IEPs) where assignments could be monitored and rewards given, as well as other programs such as Cogmed or other ADHD type programs.

According to one aspect, the disclosed system 100 may employ Software as a service (SaaS), which allows frequent updates, low sales overhead and allows the provider to virtualize the hardware and operating software. In particular, SaaS may be utilized to power online social communities such as creativity or collaborative networks for targeted users, or a support/social community or network for assisting users.

The presently disclosed system may be configured as a closed community. The system users may initially consist of adults that have/need regular access to a targeted user and his/her calendar (i.e., natural parents, stepparents, legal guardians, as well as siblings with overlapping assisting users and trusted third party baby sitters, nannies, au pairs, etc.). A next tier may include other system users, and yet a next with other assisting users such as educators, case managers, healthcare professionals, and other key players in a targeted user's life.

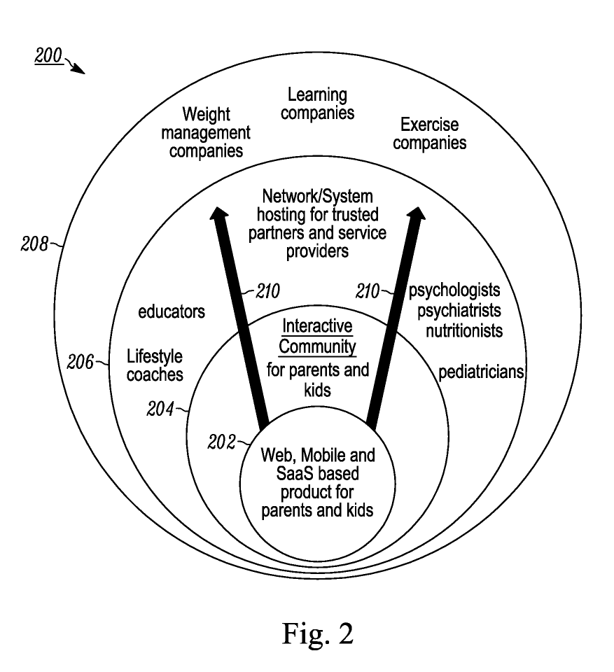

To show this hierarchy of the system, FIG. 2 illustrates a hierarchical diagram 200 of network relationships in system 100 between various users, social networks/communities, and finally other various partners/service providers. As may be seen, at the core of the system is a web, mobile, and/or SaaS based application 202 that is used by assisting users (e.g., parents) and their targeted users (i.e., children). The other levels 204, 206, and 208 are peripheral to this core as illustrated by arrows 210. After 202 is a social or interactive network community 204 where users may communicate and collaborate with other users of system 100. Additionally, the system 100 may include at further levels 206 providing a network hosting for other users such as educators, schools, coaches, or healthcare professionals to interact with or as assisting users in helping behavior modification for the targeted users. Finally, the system 100 may provide connection to outside entities such as weight management companies, health and exercise facilities, learning centers, and so forth, as indicated by the furthest periphery 208.

In particular aspects, the disclosed system 100 enables parents or assisting users and kids or targeted users to better manage the targeted user's schoolwork and extracurricular activities. The data set-up in the downloadable version is transferable to the upgraded version of the product. Additionally, the disclosed system effect behavioral changes by teaching and assisting with students' project management, planning and time management skills while serving as a change agent to promote positive behavioral changes in the areas of etiquette, social graces and character development using a built-in reward system. Additional aspects or modules for wellness, weight management and building child-parent trust (i.e., enabling Parents or assisting users to maintain confidence in their child as he/she begins to have greater freedom), financial management, and so forth are also contemplated to provide a more holistic system for engendering behavioral changes in many areas.

In one aspect, the system is a software application that affords management of a targeted user's schoolwork and assignments by breaking work and assignments into manageable tasks. The targeted users receive reminders and checklists pertaining to their assignments and activities. A user's calendar such as school schedule, assignments, work progress, after school activities and social commitments are synced with an assisted user version of the software. The product combines cause and effect with positive reinforcement to teach project and time management, promote more effective study habits and organization skills, teach proper etiquette, create good social skills, build stronger character and help with other desired behavior changes in children.

Targeted users may enter tasks (e.g., schoolwork assignments) into the system via a targeted user interface, assisted by a visual and graphical user interface complete with icons that minimize the amount of typing, plus auto correction and auto word suggestion features. This product will leverage to the greatest extent possible all of the user experience features available on iPhone and iPad, as examples, or that of any other type of device being supported. In particular, the Application may allow users to enter and track assigned tasks, due dates for tasks, and activities on a smart device and share the information with the assisting users (e.g., assisting users or guardians). The system allows the assisting user to see the targeted user's school workload and extracurricular activities as well as send information to the targeted user. The system notifies both the targeted user and assisting user about assignment status, if the targeted user is overextended or when the targeted user falls behind schedule in their work. The assisting user can access this information either via a mobile device or online for one or multiple targeted users.

In addition to activity tracking, the present system supports out-of-the-box “to do” lists (i.e., Get Done Lists), customizable checklists (i.e., Prep Lists) and automatic Reminders to the targeted user and/or assisting users. Lists can be automatically triggered by an event or printed on demand whereas reminders are time-sensitive and event generated. The application automatically rewards targeted users for desired behavior within the application like frequent usage and completing assignments. Targeted users receive an intrinsic reward from the system when tasks are completed, by exercising their choices for eliminating tasks and assignments from the system Application schedule.

Assisting users can use system applications to determine what motivates their targeted user(s), set goals for their targeted user(s), and establish virtual rewards within system or rewards in the real world. Virtual rewards within the system are tracked and issued within the application. Rewards for the real world are set-up and tracked in system while the associated reward is given outside of system (e.g., trip to the movies, lunch with dad, etc.). The system application also teaches social graces to targeted users through its embedded reward system. Targeted users are given scenarios to identify proper social behaviors and in the event they are correct, they earn extra system rewards. (See the reward section for more details on how this feature works.)

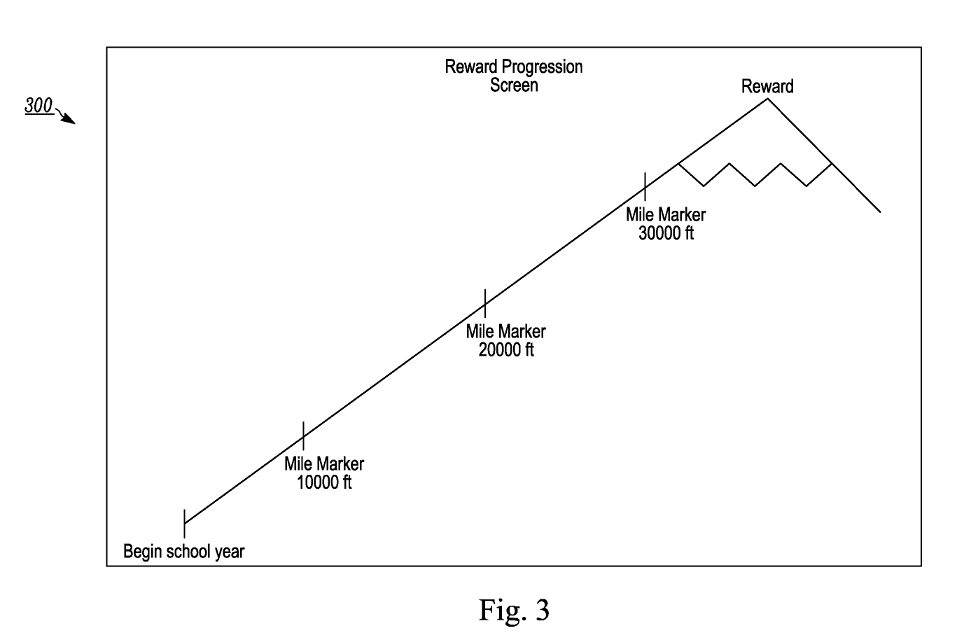

Further, a targeted user's success or reward progression in the school year (or any other desired period) may be represented pictorially. Each year targeted users embark on progress graphic (e.g., a visualized “journey” such as climbing Mount Everest as illustrated by a screen 300 in FIG. 3 or hiking the Rain Forest, etc.). The end of the school's grading periods serves as mile markers (or altitudes in pictorial representations). Although all targeted users finish the journey, the pictorial condition of their avatar at each mile marker will be better or worse contingent on the targeted user's behavior during the grading period based on the number of rewards received. The targeted user's objective for the school year is to finish the year in the best shape possible.

All system users may have profiles that define their system capabilities. In the case of assisting users, the system may be configured to determine who has access to the targeted user and whether they can update the targeted user's calendar and corresponding templates (such as “Get it Done!” lists, “Prep Lists” or rewards). For the targeted user, the profile is used to assess assignment difficulty and calculate the time required to complete individual tasks.

Targeted User Profile

Each targeted user has a system profile that includes rudimentary or basic data about the targeted user (e.g., targeted user name, grade, gender, birthday month, birthday day, mobile phone number, email, etc.) and the target user's school (e.g., name of school, school phone number, city, state and county of school, school mascot, school calendar (i.e., first day of school, last day of school, grading period end dates)). In the event the grading period end dates are not known, the system may be configured to calculate quarter end days (by dividing the school year into 4 equal periods) which can later be changed), school holidays, (i.e., federal and state holidays, teacher work days, etc.) as well as any other observed days such as family or religious holidays that may be on multiple targeted users' calendars. School data may be copied for other family members going to the same school or in the same school district. Likewise, any personally observed dates that were added to the school calendar (i.e., family or religious holidays) may also be copied to other targeted user's profiles within the same family.

The targeted user profile may also include the targeted user's school transportation schedule (i.e., the time the targeted user departs for school and the time the targeted user arrives home from school), school start time, school end time, dinner time, as well as the ideal bed time for the targeted user. These are selected using the standard scroll dial found in mobile devices.

Targeted users also get to choose how their homework assignments disappear once they are completed. Options include bombing the task, a magician makes it disappear, mice scurry it “away,” an elephant stomps it, a crocodile eats it, a targeted user waves a wand and dissolves it, etc.)

Icons for entering assignments may include, but are not limited to, the following examples: Book—reading assignments; Pen & paper—writing assignments; Colonial hat—history assignments; Globe—geography assignments; Person running—PE; Palette—Art assignments; Musical note—music assignments; Numbers—math assignments; PC—Computer science/keyboarding. The targeted user's classes are also added, selected from a menu scroll list or icons. Some targeted users—such as those in grades 4-6, may be given the option to select from the following classes: Reading (book icon); Math (numbers icon); History (colonial hat icon); Spelling (dictionary icon); Science (microscope icon); Art (palette icon); Geography (globe icon); Language Arts (pencil icon); Computer science/keyboarding (PC icon); Music (musical note icon); Resource; PE (runner icon), etc.

In another aspect, targeted users in grades 7-8, for example, may be allowed to select their particular school subjects from the following, which may also be represented by icons, such as Math, History, Civics, Science, Health, English, Computer science, Physical Education (PE), Music, Art, Geography, Resource, Drama, etc.

For each subject being studied by the targeted user, the assisting user may be allowed to further assign a level of difficulty (ranging from extremely easy to extremely hard using a system “Challenge Bar”, which is a pictorial representation of a bar type graph showing difficulty from easy to hard) and identify whether the class is considered advanced for the grade. Gifted and Talented classes would be considered advanced for the grade and would be indicated in the profile for use in estimating assignment completion times. Assisting users may also identify whether the targeted user is required to maintain any form of log such as a Reading Log or a PE Log as well as the information to be maintained in the log. In the case of the reading log, the following templates may be provided: Book title, Book author, Book publish date, Total number pages, Minutes read per day, Fill in the blank (i.e., create a new data descriptor). In the case of the PE log, a template may be provided with the following fields: Date of activity, Description of activity, Time spent on activity, Level of difficulty, and so forth. It is noted that other logs may be created for other types of activities and that reading or PE are just a couple of examples.

In another aspect, the system may either provide the ability to enter or may retrieve particular assisting user information such as contact information (i.e., name, email address and phone number) for the principal, teacher(s), case managers, healthcare professionals, and so forth.

In order to determine the amount of free time a targeted user has available for school and work, all existing targeted user's activities and commitments are added to the calendar. This includes extracurricular activities (e.g., recurring sports practices or lessons), future dated special events (e.g., parties, sleepovers, band, chorus or orchestra concerts, etc.) or any known activity (e.g., Chinese School, Korean School, etc.) that will utilize the targeted user's time. As these activities are added to the targeted user's calendar so is travel time and any special tasks associated with the activity (e.g., cupcakes for 24, bottled water for 20, birthday present, etc.). A built-in travel feature enables assisting users to calculate travel time (in 15 minute increments) and incorporate it into both the assisting user's and targeted user's calendar while a prompt reminds targeted users and assisting users about special items or tasks associated with the activity.

Get it Done and Prep Lists

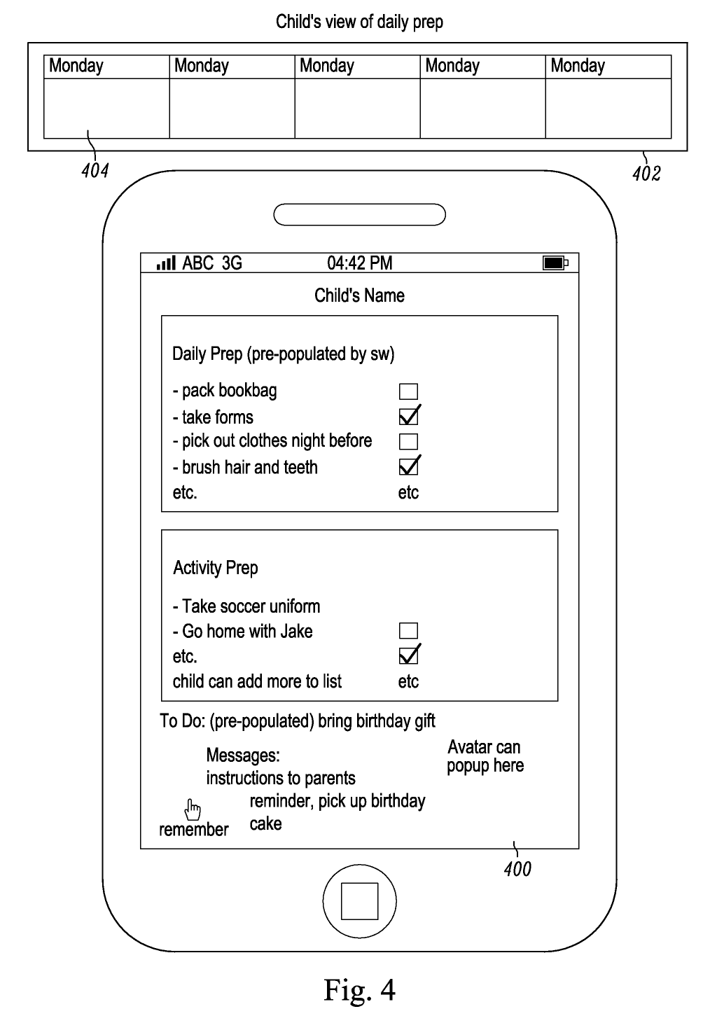

All tasks associated with the activity (i.e., cupcakes for 24, bottled water for 20, birthday present) will appear on the targeted user's “Get it Done List” until the task is either completed or the date has passed. As merely one example, FIG. 4 illustrates an exemplary screen layout 400 of a “to do” or “Get it Done” list representation that may be displayed on a computer interface or mobile device. The Get It Done Lists may be configured as predefined, customizable lists used as a tickler to remind targeted users of obligations. For example, whenever a birthday party is added to the scheduler, the software automatically adds “buy a present” to the Get Done List with the party date as the due date; take birthday present will appear on the Prep List for day of the birthday party. Likewise, when the targeted user is assigned a project that requires a costume, the software automatically adds the purchase/creation of a costume to the Get Done List along with the due date; take costume will appear on the Prep List generated for the day the costume is due. Targeted users can also add items to the Get Done List—like, get permission slip signed, bring food for a school party, etc. The targeted user does this by selecting from a list of options or clicking on icons.

As new activities are added, corresponding Prep Lists such as 402 in FIG. 4 are created, based on system templates. A Prep List, such as 402 (which is shown unpopulated in FIG. 4) is a list of tasks associated with a specific time (e.g., morning routine, nightly routine, travel, etc.) or a list of items for a specific activity (e.g., soccer practice, music practice, birthday party, etc.). The list may be arranged by days of the week (404) as shown in FIG. 4, where tasks for each day may be listed. Prep Lists serve as a reminder to the targeted user to help insure that the targeted user is properly prepared for each activity or event and help the assisting user avoid unnecessary trips to school, return trips home, etc. For example, a targeted user receives the Morning Prep List each morning, which is customized for each school day. For example, the Prep List will indicate all the items needed for school on any given day—contingent on the targeted users schedule and activities for the day (e.g., Math homework, PE uniform, band instrument, lunch, etc.). Prep Lists templates exist for common activities that can be personalized. Icons make set-up fast, easy, and entertaining. Additional Prep Lists may also be created by the assisting user or targeted user.

Templates support the features (e.g., cutting, pasting, etc.) of the device on which the application is being used. The Prep List may include one or more of the following templates with one or more attendant fields: Daily routine (e.g., Brush teeth, Brush hair, Take medication, if applicable, Make bed, Feed dog and cat, and so forth); Daily items to take to school (e.g., Musical instrument, Lunch, Gym clothes, Watch, Phone, Textbooks, All homework and projects due for the day, Notice of any incomplete homework due for the day, and so forth); Nightly routine (e.g., Complete homework, Organize backpack, Layout clothes for tomorrow, Shower/bath, Pack lunch, Brush teeth, and so forth); Items to take to activities or events (e.g., Sports practice: Soccer—Cleats, Shin guards, Soccer ball, Water bottle, etc.).

Assisting User Profile

Assisting users are anticipated to either set up the targeted user profile for younger targeted users (e.g., 4th graders) or help them set up their profiles whereas older targeted users are anticipated to create their own profile. Assisting users also have a system profile used to identify multiple targeted users, multiple schools, as well as their preferences for configurable system activities and transactions. As one example of how system controls may be configured, the following example assumes multiple levels of assisting user controls:

The first level may be an Administrator level. In this level, one assisting user serves as the administrator for the system, which controls all adult access to their targeted user(s). The administrator may grant access to their targeted user by other assisting users. The assisting user administrator also determines which adults in the inner system “assisting user” circle can update the targeted user's calendar, update Get It Done Lists, update Prep Lists, issue rewards, or communicate with the targeted user. The administrator also authorizes who is connected via the system message board, which is a communications tool within the system. Other permissions include whether the targeted user can enter or delete recurring activities, such as seasonal sports practices for example.

The administrator level may also be configured to establish the icons to be used for the targeted user's school subjects (e.g., number for math, musical notes for music, books for reading, etc.) and extracurricular activities (e.g., soccer ball, musical instrument, tumbler, etc.), based on the available system icons.

A second control level may include a responsible Assisting user or Trusted Third Party with update capabilities have access to see and update a targeted user's calendar. Responsible Assisting users. Yet a third control level may include Trusted Third Parties with view only capabilities have access to see a targeted user's calendar but are not able to update the targeted user's calendar.

All assisting users and trusted third parties are able to synchronize their targeted user's schedule to their calendar of choice (e.g., Microsoft Office Outlook or Apple iOS calendaring). Assisting users may synchronize all events, only those involving transportation, or only selected events (i.e., individual calendar updates) which they set up in their profile. Assisting users and trusted third parties may also select their communiqué mode (i.e., system message board, email, text message) as well as the frequency of the communiqués (i.e., real time, daily at time determined by the assisting user/third party, or upon request. Assisting users can also set the time for the Evening Status report, which goes to both the targeted user and the assisting user advising them of all assignments due the following day and specifying those not yet completed.

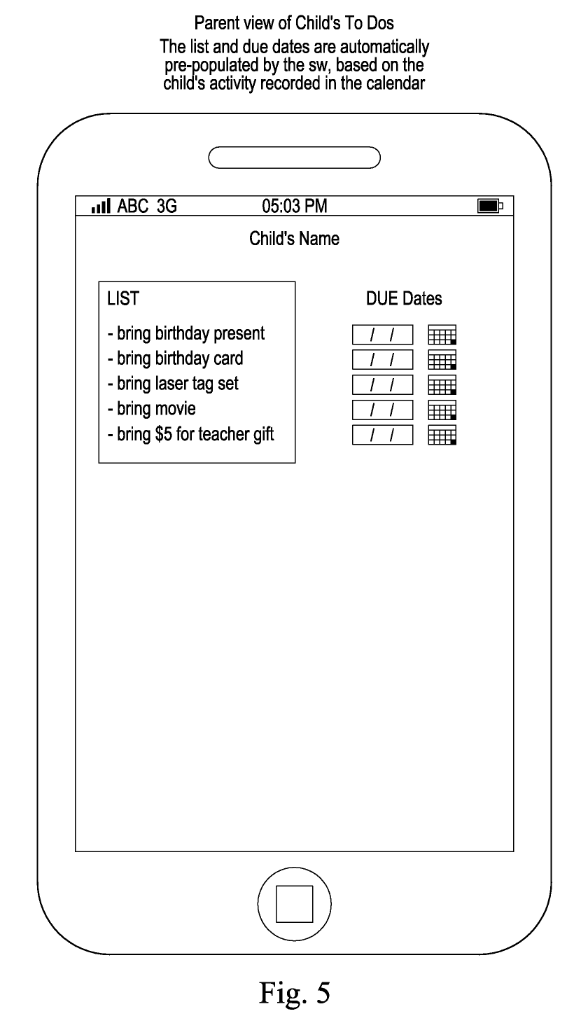

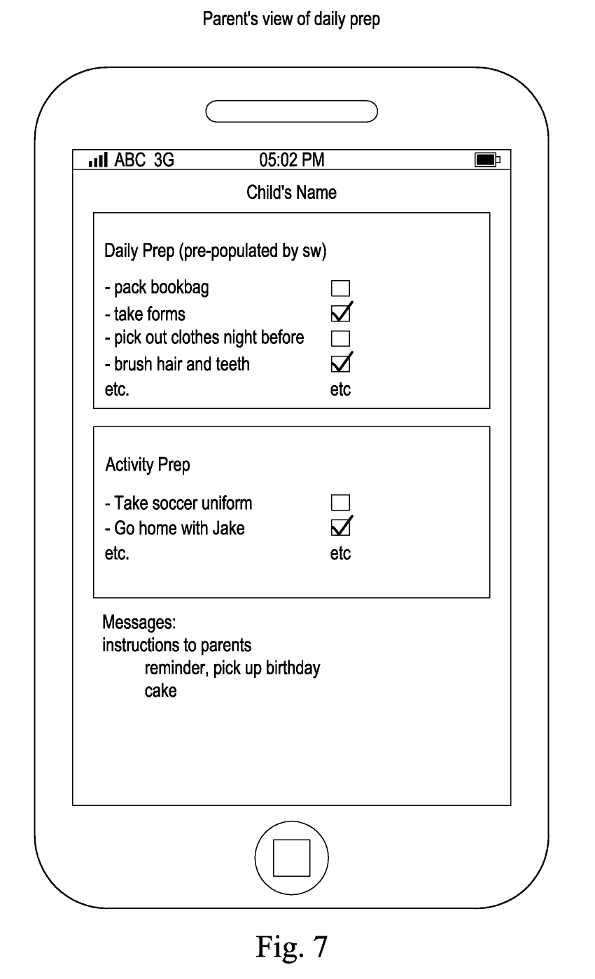

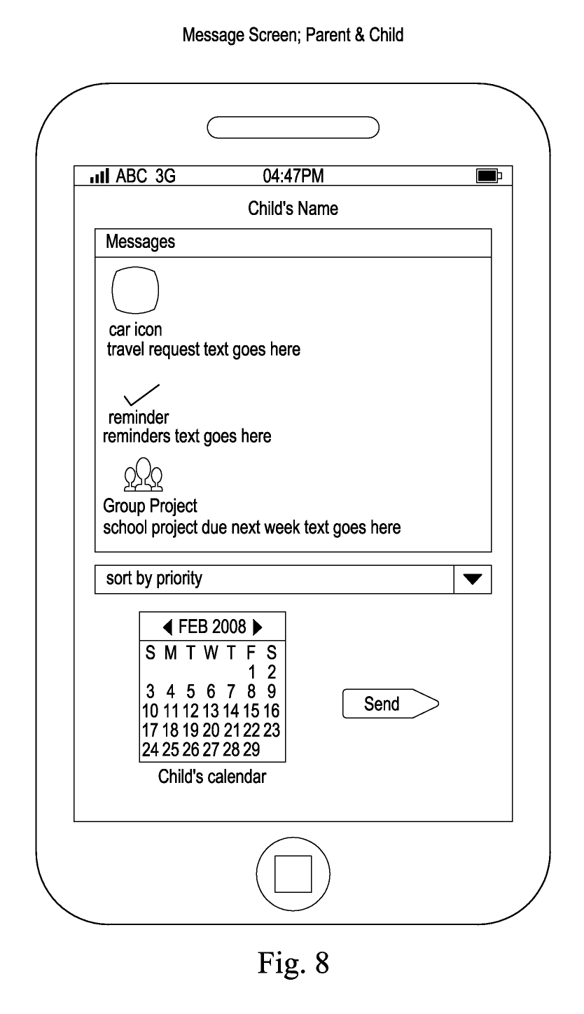

All assisting users and trusted third parties have view access to the targeted user's To Do, “Get it Done!” and Prep Lists as illustrated by screen examples shown in FIGS. 5, 6, and 7, respectively. Assisting users also may receive communicated information messages (termed also “communiqués” herein) regarding the targeted user, such as late assignments, the targeted user's accomplishments, the targeted user's workload, and Evening update reports, etc. An exemplary view may be seen in FIG. 8.

In an aspect, the system product combines a graphic user interface with gaming techniques and animation to make learning and task completion more enjoyable. Students may interact with the system product through a personalized avatar (i.e., a user's representation of him/her in a picture icon) and encounter multiple characters on as improved school performance or changed behaviors are engendered. Additionally, the graphical representations may be presented in two dimensions, such as on a computer or smartphone screen, or could be also presented in a three-dimensional environment, and/or virtual reality type environments.

Graphical Avatars

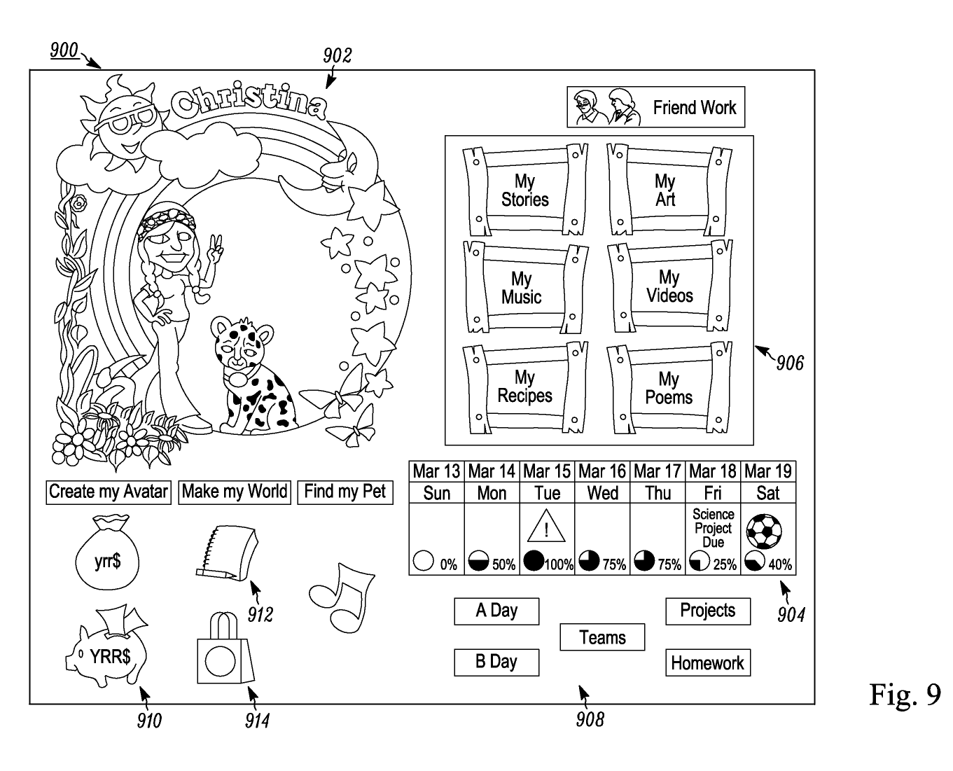

Both targeted users and parents or assisting users have the option to interact with the system community via a self-designed avatar. In an aspect, the avatar may be created by combining the basic body shell of an animal or human and other, color and typical features such as face shapes and hair colors with a name and general temperament. Examples of different user selectable features include the following: Likeness (e.g., Cat, Dog, Lion, Bear, Eagle, Horse, Human-like male, Human-like female, etc.); color; features (examples include: Hair color, Hair length, Hair style, Eye shape, Eye color, Nose shape, Avatar height, etc.); naming of avatar; selecting characteristics including descriptor words (examples include: Friendly, Likes to learn, Curious, Likes to play, Proud, Quick witted, Bold, Graceful, Mysterious, Strong, Surefooted, Leader, Individualist, Crafty, Fast, Elusive, Talkative, Spunky, Confident, Fun-loving, Good sense of humor, Very social, Loves the mountain, Loves the ocean, Cautious, Good negotiator, Quiet, Soft spoken, Wise, Enjoys the moon, Enjoys the sun, Elegant, Savvy, Insightful, Energetic, Dependable, Protective, Full of surprises, Fiercely independent, Soft spoken, Enjoys being alone, Enjoys being with friends, Enjoys being in nature, Enjoys being in big cities, Fierce, Fiery, Intelligent, Kind, Brave, Gentle, Fair, Problem solver, Determined, Clever, Creativity, Outgoing, Entertaining, Nimble, Flexible, Prankster, Chatty, Jokester, Gentle, Pleasant, Thrifty, Calm, Smart, Persistent, etc.). Should a user such as a student or parent chose not to design an avatar, a user may also have an option to use a standard system-created avatar. An exemplary avatar is illustrated by graphic 902 in exemplary screen display 900 in FIG. 9 for a targeted user.

Avatars are used to demonstrate cause and effect for both positive and negative actions contingent on the behavior the targeted user has been exhibiting. For example, the avatar may shrink, if the targeted user exhibits an embarrassing behavior like rudeness or the avatar may become larger or smaller contingent on the ratio of exercise and food consumption the targeted user has, the avatar may become ugly if the targeted user is unkind to someone, the avatar's clothes may become shabby if the targeted user does not exhibit charity, etc. Assisting users can visualize their targeted user's behavior in a chart/checklist that shows trends and process.

System Functionalities

The system product integrates school requirements into the targeted user's personal life, giving both targeted users and assisting users a holistic view of targeted users' activities and time commitments. Targeted users and assisting users share a calendar where both can track progress, identify over-commitments, and recognize the targeted user's accomplishments. Targeted users are rewarded within the software and by assisting users in the physical world for timely completion of academic work and the exercising of proper etiquette and social skills in real live scenarios.

The product combines a graphical user interface with gaming techniques and animation to make learning more enjoyable. Targeted users “live” in the system through their avatars (i.e., a user's representation of him/her in a two-dimensional picture icon). Each school year, for example, starts a new journey for the avatar. The avatar's successes in the school year are represented pictorially, such as shown in FIG. 3, using school grading periods as mile markers, and this pictorial may include the targeted user's avatar (not shown in FIG. 3) The pictorial condition of the avatar at each mile marker will be better or worse contingent on the targeted user's behavior and successes during the grading period as indicated by the number of rewards received. Rewards can be used to buy supplies that make the avatar's journey easier.

During the journey, the system may be configured to allow the avatar to encounter multiple characters over time and/or after completed tasks that may help or hinder the avatar's journey to improved behavior performance. These characters effect various system functions such as correction, encouragement, accounting, buying, trading, and or donation of system rewards, comic relief, advice, etc. In the system application, these functions may be represented with picture icons or avatars and may include one or more the following:

(1) An antagonist character that does “evil” things, like trying to steal a targeted user's rewards. The antagonist character may embrace “negative” behavior while concurrently pointing out the real consequences of a potentially bad choice—showing age appropriate cause and effect without judgment. For example, a targeted user may choose not to study for a test or multiple tests and as a result, receives a less than satisfactory grade. The antagonist character may tell the targeted user “way to go! Your parents aren't going to have to worry about paying for your college education.” In another example, the targeted user may choose an inappropriate response when presented with a social behavior scenario, which results in the targeted user hurting another targeted user's feeling. The antagonist character will display to the targeted user, “Wow, that's a great strategy to avoid being invited to birthday parties and sleepovers! Way to go!”

(2) An encouraging character who assists and coaches targeted users through difficult assignments through “help” pop-ups.

(3) An accounting character used to represent administration of currency rewards to targeted users when they have earned system rewards.

(4) A “shop keeper” character used to represent administration of a system “store” where targeted users may trade system currency for desired items, such as Avatar items as one example.

(5) A comic character configured to display jokes, or point out funny things.

(6) A charitable character configured to administrate a system Charity and accepts donations and contributions for those less fortunate.

(7) An advice character configured to dispense advice to targeted users in dealing with daily life.

It is noted that the above functions are merely exemplary, and further functions and associated system characters may be implemented.

The system also incorporates surprises, which are not rewards but are positive events that occur under certain conditions. Surprises occur randomly (e.g., every nth, nth+x transaction) or can be triggered upon certain events, identified and set up by assisting users—such as completing 3 consecutive assignments on time in row, etc. Surprises include, but are not limited to such items as jokes, currency (i.e., system credits), and personal rewards for avatars. Surprises occur during the targeted user's first online session, the first time the targeted user has been online for 3 days, on the targeted user's birthday and the last day of school.

In another aspect, a targeted user's avatar may become friends with other avatars, just like in real life. Avatars can be admitted to another avatar's inner circle upon request. Avatars communicate with one another by sharing assignments with one another, collaborating on projects with one another, sending communiqués, and so forth. Email addresses and mobile phone numbers are used to identify avatars making friendship requests. In another aspect, this “friending” function may be controlled by assisting users for targeted users under the age of 13, as one example, such that the targeted user must have assisting user permission to admit others to their inner circle.

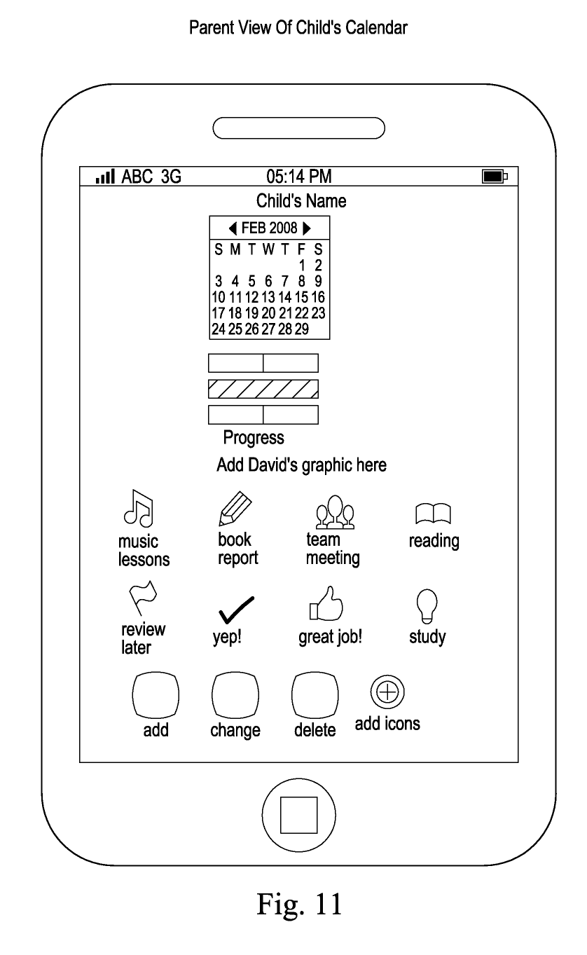

Targeted users (and assisting users) may be offered the selection of different ways to view perspectives of targeted user lives, such as daily, weekly, and monthly views. Days and weeks are portrayed graphically as illustrated in screen 1000 in FIG. 9 to show the amount of time committed and the amount of time available to the targeted user. Daily, weekly and monthly views show the percent of free time using a small graphic (like a speedometer icon or a temperature icon, or a simple circle that's empty, ¼ full, ½ full, ¾ full and completely full) for each day based on the activities and assignments depicted on the targeted user's calendar. The system also includes the functionality of displaying a targeted user's calendar to the assisting users as illustrated by FIG. 11.

In addition to academic assignments (e.g., homework, school assignments, school projects, etc.) the system may also be configured to allow other types of activities to be entered, stored and managed within the system, such as household chores, family events, social events, extracurricular (e.g., soccer practice, piano lesson, etc.), personal (e.g., orthodontist appointment, dental appointment, etc.), service (e.g., work at food bank; attend meeting of Habitat for Humanity, etc.), religious (e.g., attend service, etc.), etc. Both targeted users and assisting users/trusted third parties (with appropriate levels of access) may add, delete or modify all targeted user activities. If the targeted user updates the calendar, the assisting user is notified. If the assisting user updates the calendar, the targeted user is notified.

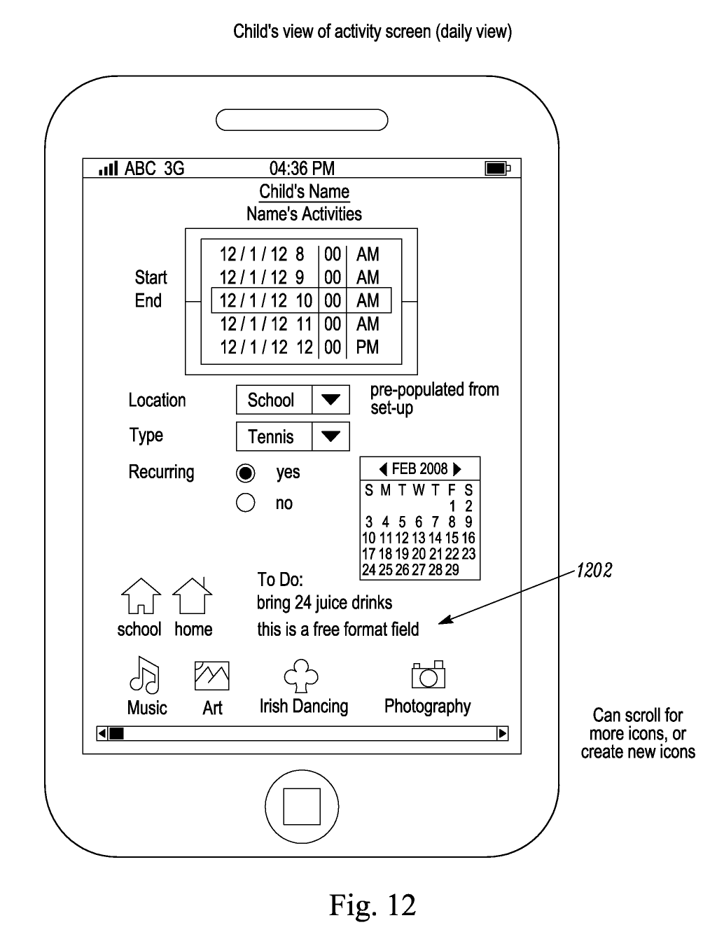

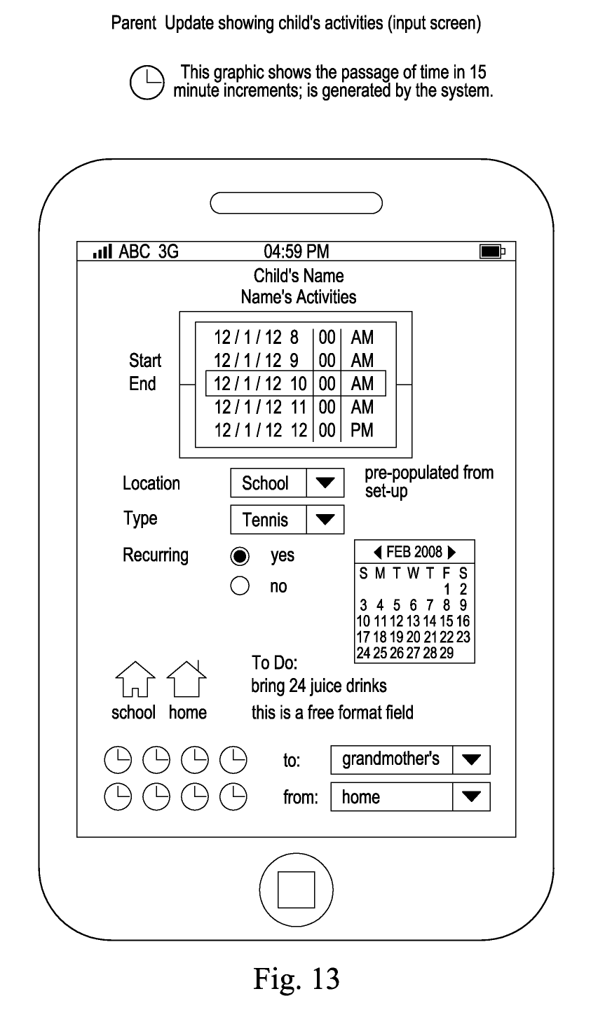

In one example, activities may be added by entering the start time and end time using the iPhone time wheel or similar mechanism for other devices An exemplary screen for activity view to a targeted user and the functionality for entering activities is illustrated in FIG. 12. An exemplary screen for an assisting user's complementary activity view to a targeted user and the functionality for entering activities is illustrated in FIG. 13. If the activity is identified as recurring, the start and end date of the activity is required. A location is also enterable for all activities. In the case where the location is not the targeted user's home, the system may also include travel time calculation. Should the location not be the targeted user's home and travel time is not added, the assisting user is reminded to add travel time to the schedule when the assisting user's system calendar synchronizes with the targeted user's system calendar. Assisting users are also reminded to determine who will be responsible for providing transportation—mom, dad, car pool, etc. Each time an activity is added, there is an option to update or create a Get It Done! List for the related tasks (e.g., bring snacks, need $10 for coach gift, etc.). These activities may be represented as icons and/or checklists in the software for faster input. For example, travel is represented by a car. Art lessons are depicted as a palette, and so forth. If travel is required for an activity, assisting users are reminded to expand the length of the time requirement for the activity to include travel time when the activity is synced to their calendar.

Other activities, such as household chores, may include a field for a completion date, similar to assignments or tasks. In the event the targeted user has not completed chores by the requisite time and date, the activity may be visually changed in some manner (e.g., to become highlighted in YELLOW, as merely one example), and the assisting user is notified.

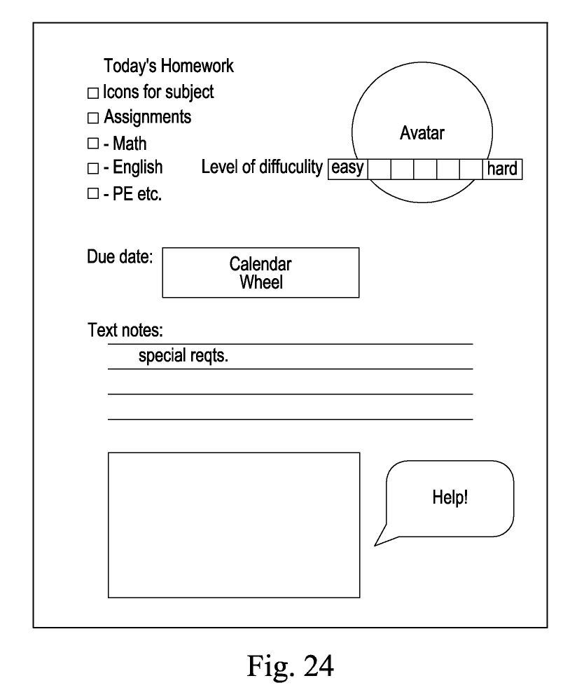

Academic assignments may be entered by targeted users. The system application may be configured to incorporate as many usability features as possible from the iPhone, iPad, and Android operating systems, including icons for entering assignments, autocorrect, and auto-suggest for entering text. When assignments are added to system Application, targeted users answer a series of questions about the assignment. Then the targeted user is guided by system Application and taught how to break down assignments that 1) require multiple tasks and 2) allocate time for the tasks occurring over multiple days. The system may be configured to automatically create a project plan based on the due date of the assignment, the level of difficulty of the subject (as indicated in the targeted user's profile), the targeted user's perception of the task difficulty (identified at the time the assignment is added to the Application by the targeted user), and the targeted user's current work load and commitments. Time is allocated for each task using system -developed algorithms. Initially, these time allocation algorithms will be generic and universal for all targeted users, but over time, system Application will learn from actual targeted user results and make estimates based on the targeted user's previous work for similar projects in similar subjects. An exemplary screen for entering assignments may be seen in FIG. 24.

Assignment information can be added directly by the targeted users or received electronically upon request from other targeted users in the same school, grade, class and classroom teacher. Any targeted users who appear to be abusing this feature by blasting information can be blocked from using it.

When entering assignments, the targeted user first identifies whether the assignment is for the targeted user (i.e., homework) or the assisting user (e.g., get signature on permission form, send check for $25, etc.) by selecting either the assisting user icon or the subject icon and entering the due date. If the assisting user icon is selected, the targeted user selects the assisting user activity (e.g., get signature, need forms, etc.), enters the due date and the assisting user is notified.

If the assignment is for the targeted user (i.e., subject icon is selected), the due date defaults to the next class meeting with the option for the targeted user to change the date. The targeted user then selects the type of assignment by identifying the work to be submitted. Possible options, supported by icons, may include “Nothing, just reading”; Worksheet, need to fill in the blanks or answer questions; Drawing, need to color, paint, cut and/or paste; List of questions, problems, questions, definitions; Study for test, pop, quiz, regular test; Writing assignment; or Project. Once all assignments have been entered in the system, a task plan will be created and displayed visually on the calendar for acceptance by the targeted user. Additionally, the system may be configured to prompt for responses for each type of assignment as given below.

For reading, the system may be configured to display a prompt with blanks such as “page ______ to page ______” to allow entry of start page and ending page number, or “ ______ pages” to enter a number pages to be read, or “ ______ minutes” to enter a time such as the number of minutes to read. If the subject has a corresponding reading log, display the last three entries to the log, allow “the number of pages to be read ” to be changed, a new entry for an existing book, or ability to enter a new book. The targeted user chooses which options works best for the assignment. The targeted user may do the following: update the number of pages read for the previous book or to start a new entry in the reading log. Returns targeted user to screen for assignments. Enable the targeted user to indicate the level of difficulty of the assignment (e.g., entry on the system using a “Challenge Bar”) and to estimate the amount of time they think the task will take them showing the four system time clocks with increased time in 15 minute increments. A ?? or similar icon could be provided to the targeted user to denote “I don't know.”

For student worksheet, the system may be configured to prompt for the number of questions or problems showing the number dial, enables the targeted user to indicate the level of difficulty of the assignment on the system Challenge Bar and to estimate the amount of time they think the task will take them showing the 4 system time clocks with increased time in 15 minute increments. A ?? icon denotes I don't know.

For drawings, the system may be configured to prompt for how many drawings using the number dial and displays three different sizes denoting small, medium, and large for the targeted user to select. The system enables the targeted user to indicate the level of difficulty of the assignment on the system Challenge Bar and to estimate the amount of time they think the task will take them showing the four system time clocks with increased time in 15-minute increments. A ?? icon denotes I don't know.

For assigned questions or problems, if the subject is something such as spelling, the system asks for the number of words using the number dial and if sentences need to be written for each word. For other subjects, the system could be configured to ask for the number of problems or questions. The system enables the targeted user to indicate the level of difficulty of the assignment on the system Challenge Bar and to estimate the amount of time they think the task will take them showing the four system time clocks with increased time in 15-minute increments. A “??” icon denotes I don't know.

For assigned or needed study, the system may be configured to prompt the targeted user to enter the content of the test and what material (i.e., scope) is being covered. (This is to help the targeted user frame the concept of the material.) The first x times, the “Encouraging” character, for example, can be configured to display with some appropriate examples (e.g., Content =multiplication, content=1*1 to 5*5 or subject=protests, scope=chapter 7).). Additionally, the system may be configured to prompt the targeted user to list the material required for studying and show another help pop-up with an example (e.g., textbook, handout, flash cards, etc.) and show an icon for further assistance, which links to a source, that explains how to study. The system enables the targeted user to indicate the level of difficulty of the assignment on the system Challenge Bar and to estimate the amount of time they think the task will take them showing the four system time clocks with increased time in 15-minute increments. A ?? icon denotes I don't know.

For writing assignments, if the due date of the assignment is beyond the next class meeting, the system may be configured to treat this assignment as a project, but is not necessarily limited as such. In an aspect, if the assignment is due the next class, ask the targeted user how many sentences, paragraphs, or pages are required and allow the targeted user to respond to one using the number dial. The system enables the targeted user to indicate the level of difficulty of the assignment on the system Challenge Bar and to estimate the amount of time they think the task will take them showing the four system time clocks with increased time in 15-minute increments. A ?? icon denotes I don't know.

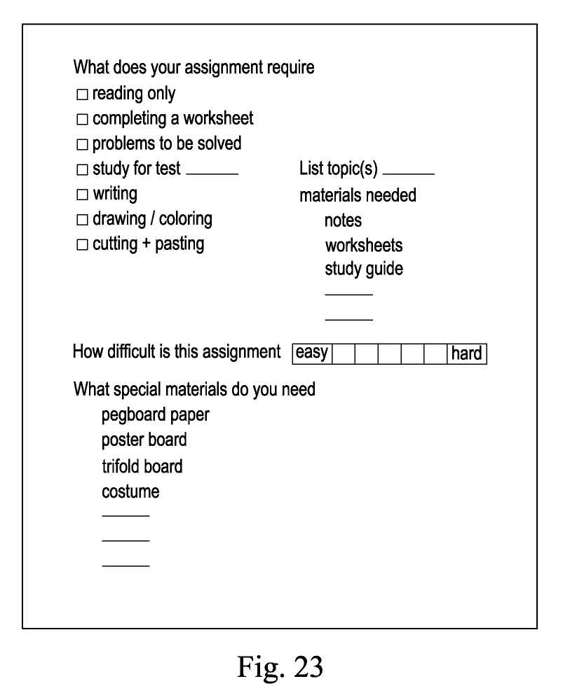

Once a type of assignment is selected, the system may be configured to show the due date as the next day that the class meets and allow the targeted user to change the due date, display a confirm icon for due date confirmation, flash a purchase icon or screen for selecting and storing items in the system(e.g., in a dedicated screen for item purchases as illustrated in FIG. 23 or on some other screen alternatively such as 1202 in FIG. 12) to remind the targeted user about items needing to be purchased for the assignment, highlight or display an assisting user icon to remind targeted user (or alert the assisting user) if there is something they need from their assisting user for the assignment, as merely a few examples. The system may be configured to allow the targeted user to either change the due date or confirm the default due date. If a due date is entered and it is beyond the date of the next class meeting, the system will treat the assignment as a project. If the Purchase icon is selected, a shopping list is displayed. If the assisting user icon is pressed, the targeted user is prompted for the assisting user's assignment (e.g., review my math, proof my writing, send check, etc.) If a “More Tasks” icon is selected, targeted user selects assignment from the previous eight categories and processing follows the same logic as identified.

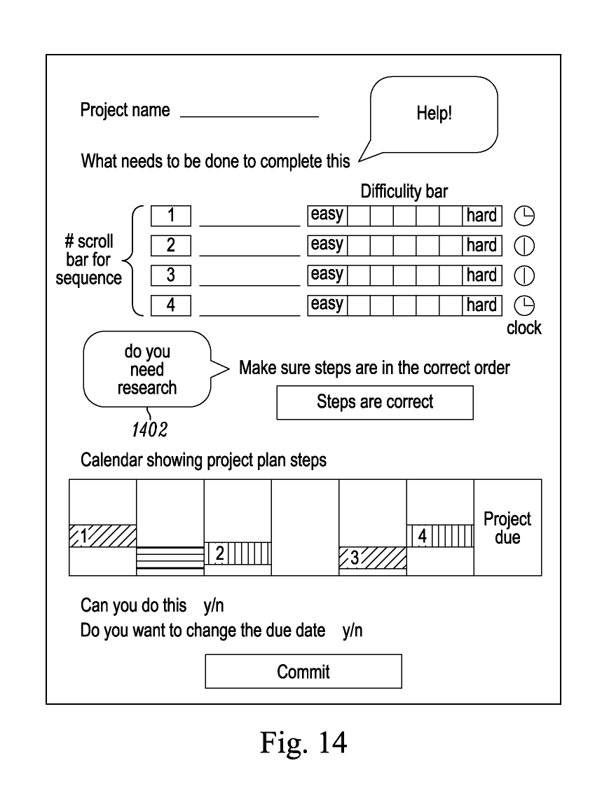

For a project assigned to the targeted user, the system may display the following options to the targeted user: “New plan? or Existing plan?” In the case of an existing plan, if the targeted user was given a project plan from the teacher (i.e., Existing plan), the targeted user will be prompted to enter the individual tasks and corresponding due dates, indicate the level of difficulty of each task on the system Challenge Bar and to estimate the amount of time they think the task will take (e.g., showing system time clocks with increased time in 15 minute increments for entry). A ?? icon denotes I don't know. An exemplary screen for project planning is illustrated by FIG. 14.

In the case of a new project, the system may be configured to guide the targeted user to create a project plan for the assignment. In an example, two icons may be shown: Create Plan and Get Help. If the Create Plan icon is selected, the system asks the targeted user to identify the steps needed to complete this assignment. The targeted user is then prompted to enter data in blanks under “My Plan.” In an aspect, the “Encouraging character” or a message (e.g., 1402 in FIG. 14) may be displayed to ask if the targeted user needs to do any research. Yes, No and Done icons may be displayed to input the targeted user's answer.

If yes, the Encouraging character asks the targeted user if he would like research added to the list of tasks. If yes, the system adds another task item for research at the bottom and asks the targeted user if the tasks are in the order in which they should be completed. If no, the system makes no changes to the tasks list for the targeted user and asks the targeted user if the tasks are in the right order. If no, the system asks the targeted user to identify the first task. Each time a task is identified, the targeted user's view is changed to reflect the new order. The targeted user selects the Done icon when the tasks are in the right order and indicates the level of difficulty of each task on the system Challenge Bar and estimates the amount of time they think the task will take—showing the 4 system time clocks with increased time in 15-minute increments. The ?? icon denotes I don't know.

In another aspect, the encouraging character may be configured to display along with a shopping list template to remind the targeted users of any purchases (costume, poster board, trifold board, etc.) that their assisting users might need to purchase for them. If the Purchase icon is selected, a shopping list is displayed. The targeted user has the ability to modify the purchase template. If the assisting user icon is pressed, the targeted user is prompted for the assisting user's assignment (e.g., Take me to school the day the project is due, etc.).

Additionally, a “Get Help” icon may be displayed and selected at any time. If the Help icon is selected, a message or the “Encouraging” character may be configured to display examples of grade-appropriate project plans, study guides, etc., based on the type of assignment identified by the targeted user.

Further, in one example the targeted user may enter one line item for the assignment, show the due date as the next day that the class meets, and allow the targeted user to change the due date, display Confirm icon for due date confirmation, flashing Purchase icon to remind the targeted user about items needing to be purchased for the assignment, an assisting user icon to remind targeted user if there is something they need from their assisting user for the assignment and a “More Tasks?” icon. The system also allows the targeted user to either change the due date or confirm the default due date. If a due date is entered and it is beyond the date of the next class meeting, the system will treat the assignment as a project. If the Purchase icon is selected, a shopping list is displayed. If the assisting user icon is pressed, the targeted user is prompted for the assisting user's assignment (e.g., review my math, proof my writing, send check, etc.) If More Tasks icon is selected, targeted user selects assignment from the previous eight categories and processing follows the same logic as identified.

In still another aspect, the system may be configured to calculate a time allotment and execution of tasks (i.e., mapping to calendar and creation of schedule) is based on the number of tasks, estimated difficulty of the tasks, weighted average of the class, the time available to complete the assignment (i.e., sum of free time for the number of days between the date assigned and the due date) the due date. The following description provides an example scenario of how this function may operate.

In this scenario, an assigned task is a next day class assignment for a 4th grader. It is assumed that the targeted user is taking the following academic classes: spelling (subject level of difficulty is 3), reading (subject level of difficulty is 3), science (subject level of difficulty is 2), math (subject level of difficulty is 8), and geography (subject level of difficulty is 4). It is further assumed that the targeted user has two homework assignments: a math assignment (5 math problems) level of difficulty is 3 (converted from system difficulty or “Challenge Bar”), and a reading assignment (read 40 pages) level of difficulty is 2 (converted from system Challenge Bar). Further assuming that the average amount of homework for a 4th grader is 1 hour, if a targeted user perceives the subject as difficult, it will take longer for the targeted user to do the homework. The system calculates the amount of free time (i.e., the number of hours and minutes between the time the targeted user gets home from school and bedtime less any activities that occur between getting home and bedtime, which is 2 hours. Then, the system assesses whether the time available is greater than or equal to the average amount homework assigned to the grade, which is 60 minutes. Average level of difficulty is 5.5 on the system Challenge Bar. The targeted user's average level of difficulty (subject & assignment) for math is 5.6. The targeted user's average level of difficulty (subject & assignment) for reading is 2.5 is not relevant because the assignment is to read for 40 minutes. Math will require about the average amount of time (2 minutes per problem). Thus, the total homework time is estimated to be 50 minutes. In response, the system is configured to show the targeted user's calendar with the assignment(s) added. (Calendar is visual with assignments weighted, based on amount of time.) The system may at this point allow the targeted user to change the pictorial representation of the assignments for the day or press the “Confirm” icon.

The targeted user's calendar is updated and the assisting user(s) are advised of the assignments. When targeted user is ready to start homework, targeted user presses the Start icon when he starts the homework and presses the Finish icon when he finishes. If the targeted user needs to take a break, targeted user presses a STOP icon (which serves as a pause button). When the targeted user returns from his break, he presses the start icon. Targeted user has option of viewing a time glass, clock, or other graphic visually counting down the respective homework assignments. When the targeted user completes the homework, he/she presses the Finish icon. The time spent on homework is calculated and stored to assist in future time estimates.

The system also calculates the amount of free time (i.e., the number of hours and minutes between the time the targeted user gets home from school and bedtime less any activities that occur between getting home and bedtime for the school days plus available weekend time, which is 45 hours. The system may then be configured to assess whether the time available is greater than or equal to the average amount of homework assigned to the 7th grade which is 2 hours per day (2 hours for 10 days=20 hours). In another scenario, the system may be configured to show the targeted user's calendar with the assignment(s) added and assignments weighted, based on amount of time. In the event the targeted user is in middle school and the targeted user appears to have the time capacity (i.e., less than x % capacity), ask the targeted user if he can complete any of the individual tasks any earlier. The accounting character (e.g., a “banker”) pops up and advises that an early finish earns extra rewards. If the targeted user does not change any of the dates, show the targeted user how many bucks are being lost by not completing the project early. Show the “No Thank You” icon and allow the targeted user to either change the due dates or press the “No Thank You” icon. The system may then return to the assignment review function if targeted user was reviewing assignments prior to creating the project plan

Special events like “Wear your PJs to School” day or big test dates (i.e., state required testing, etc.) can also be accommodated in the system. The assignment would be “wear PJs to school”, the level of effort would be 0, and the due date would be date on which the PJs were to be worn to school. “Wear your PJs to school” would appear on the Prep List the day PJs were to be worn to school.

If the targeted user finishes one of the tasks in the project plan earlier than the system calculated due date for the task, reward the targeted user with currency, and notify the assisting users. If the targeted user is below x % capacity, show the current schedule and ask the targeted user if any other project task due dates should be changed. If the targeted user indicates yes or maybe, show a proposed change by systemically advancing all associated due dates of the remaining tasks by x day(s) where x is the difference in days between the calculated task due date and the actual date completed. Allow the targeted user to accept the proposed change, manually adjust the proposed project schedule, or make no changes to the remaining schedule. If the targeted user makes changes to the schedule, update the targeted user's calendar.

If the targeted user enters a date for completing a task past the due date of the task, Encouraging character pops up and reminds the targeted user when the next task is due and that the targeted user risks falling behind in his work. Encouraging character asks the targeted user if he would like to adjust his project plan. The targeted user can change any dates associated with any tasks. If the targeted user changes the final due date past the date of the original due date, the targeted user should be asked why and to make a selection from a drop down list that may include one or more reasons such as: Weather related, Illness related, Family event, Medical appointment, School field trip, Suspension, etc.

The assisting user is notified of both the due date change and the reason for the change.

The notification to the assisting user might include suggestions on how to intervene (i.e., to request a call for a teacher conference to create plan, monitor assignments in system on daily basis, work more closely with the targeted user to ensure assignment completion, include a List “self-help” reference web sites that might be helpful, etc.).

The present system may also be configured to integrate with school software, like Blackboard, eCollege, Desire2Learn, etc.) or directly to the school's website for automated downloading of schoolwork assignments. In the event that assignments are received electronically, all assignments and due dates assigned during the day are displayed to the targeted user upon login.

If a due date is a next class meeting, in one example, the targeted user may be prompted to rate the level of difficulty using the system Challenge Bar as well as to identify any materials or supplies that need to be purchased in order to complete the assignment. Should purchases be required, the assisting user is notified; the shopping list created by the targeted user is also communicated to the assisting user. Depending on the type of assignment, the targeted user is asked a series of questions, as previously discussed. If the due date is beyond the next class meeting, the targeted user is prompted to create a project plan, as previously discussed.

Academic activities automatically default to the highest priority. In the event the targeted user has more to do than is feasible based on his/her available time, a conflict is identified on the calendar and the assisting user is notified. If an academic activity is not completed by 12:01 am on the date due, the activity becomes highlighted in YELLOW. If an academic activity is not completed by the time specified on the date due, the activity becomes highlighted in RED.

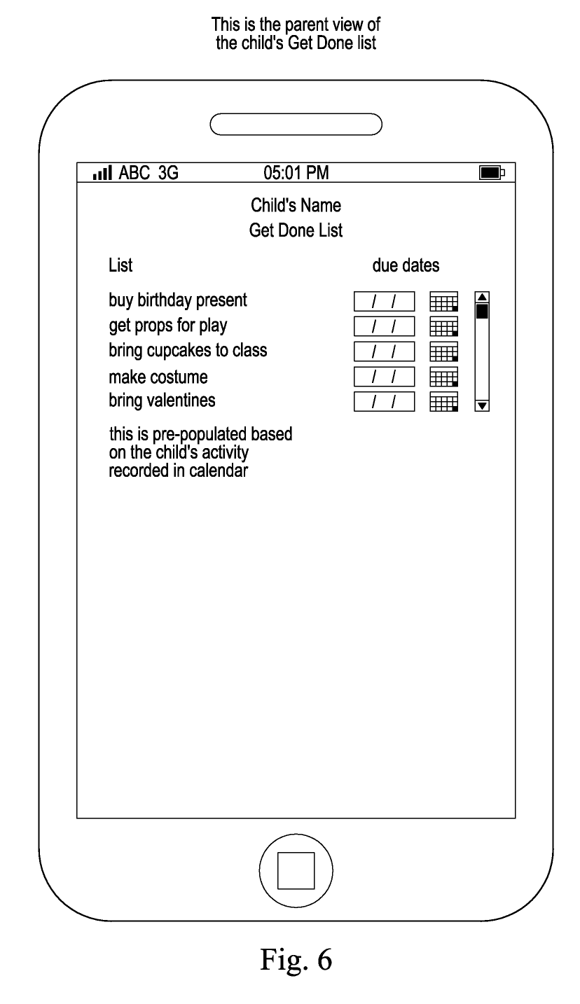

Communication messages or “Communiqués” contain information that is delivered to assisting users and targeted users in the system. Communiqués can be triggered by events, automatically generated at specified times or generated on demand. Even Status Report Communiqués are automatically generated nightly at a time determined by the assisting user's profile. This report identifies all assignments for the following day and highlights those not yet completed. Communiqués may also be generated when any one or more of the following occurs: when deadlines are approaching, assignments are late, changes have been made to project due dates, a targeted user tries to create a new project due date after the original due date is past (e.g., the due date of September 12 is changed to September 15 on September 13) , too many activities are being scheduled (i.e., the time required for activities is greater than the targeted user's capacity), scheduling conflicts arise, targeted users receive multi-day assignments, and assisting user needs to purchase something (which also shows up on the targeted user's Get It Done List as illustrated in FIG. 6), or the targeted user added a task for the assisting users (e.g., need to have a field trip form approved, has school photos the next day, etc.), as a few examples.

By checking off choices in a graphical selection screen, assisting users can determine whether they receive Communiqués in real time or once a day and what kind of information is included in the Communiqué. In another aspect, the targeted users or assisting users can request the following items on demand: list of targeted user accomplishments for specific time periods, list of late assignments, list of pending assignments for a specific time period, any log set-up for the targeted user for a specific time period and daily, weekly and monthly calendar views. If the targeted user is creating either a reading log or PE log, the log will be communicated to the assisting user weekly, based on the date the log is due to the teacher. Further, at any point in time, the assisting user can request a Targeted user Performance Report for any given period. As an example, this graphical report would identify the number of items completed and the number of deadlines missed. Assisting users also have the option to visualize their targeted user's behavior in a chart or checklist that shows trends and processes.

Although Prep Lists and To Do Lists are triggered by specific events, both can also be configured to be viewed on demand. In addition, although the To Do List is considered a tool for the targeted user, attempting to instill a sense of responsibly in the targeted user, it is also a tool for the assisting user. The To Do List identifies purchases, items that need to be made, etc. and is therefore more likely to be completed by an assisting user or responsible third party adult.

Targeted users can create reminders for themselves. If a targeted user wants to create a reminder, the targeted user must specify the time the reminder is to appear in their schedule and the content of the reminder. Reminders may also be sent to other targeted users who are collaborating on assignments. The information is transferred via the system Creativity Network. The sending targeted user must specify the time the reminder is to appear. The content of the reminder must be one of the following messages: Specific work assignment for the project, items to bring to next group working session, when and where of next meeting, or ideas/topics for collaboration sessions, as a few examples.

System Rewards/Motivation

The system may be configured to issue rewards to targeted users for schoolwork preparation and timely completion of tasks, assignments, and chores in order to motivate the targeted users and engender behavioral changes. In addition, the system may be configured to issue rewards to targeted users for demonstrating good character, social graces, and etiquette. Character building starts with the four system values: honesty, integrity, charity, and empathy. Once targeted users reach a certain reward level in system, the targeted user is presented age-appropriate scenarios dealing with the four system values. The targeted user is placed in a situation to which they must react. In each case, the scenario has multiple options that the targeted user can consider. Each response option has different reward amounts based on how well the response demonstrates the value highlighted. The targeted user is asked to select the most appropriate reaction or response to the situation and is rewarded accordingly. Physical wellness will also be rewarded once the application is available. Assisting users are also able to construct personalized scenarios for demonstrating the values that they hold important using the system character building (discussed in more detail in the Level 3 reward section below).

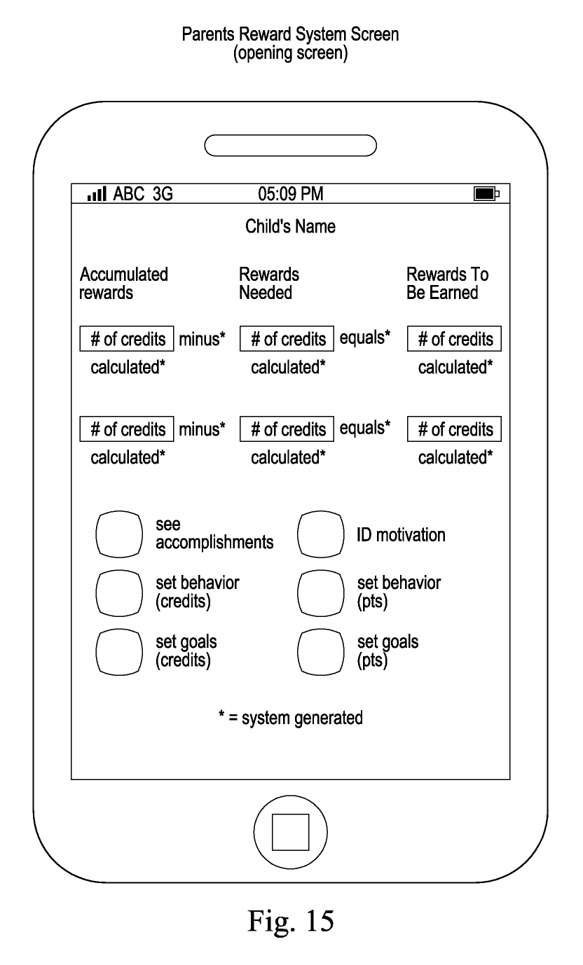

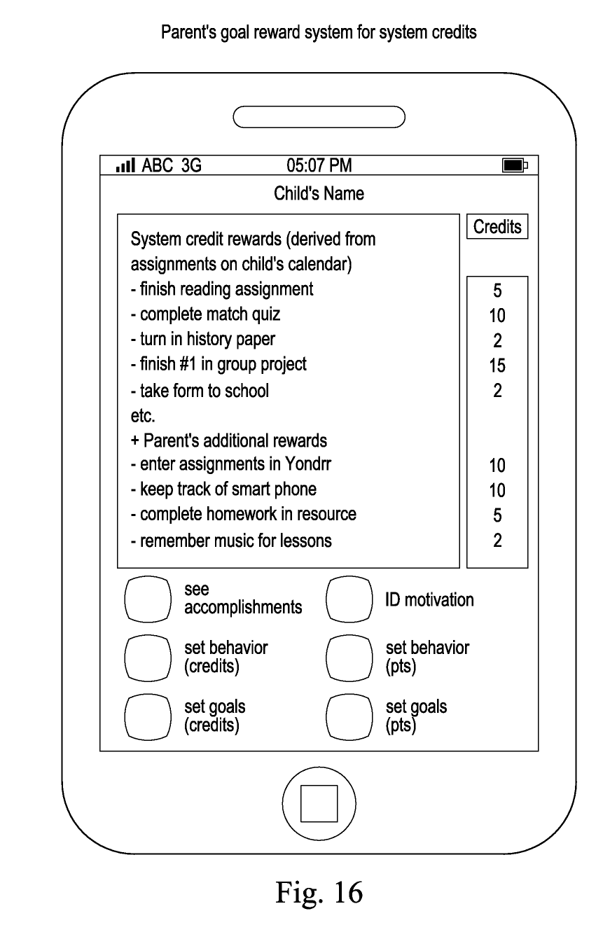

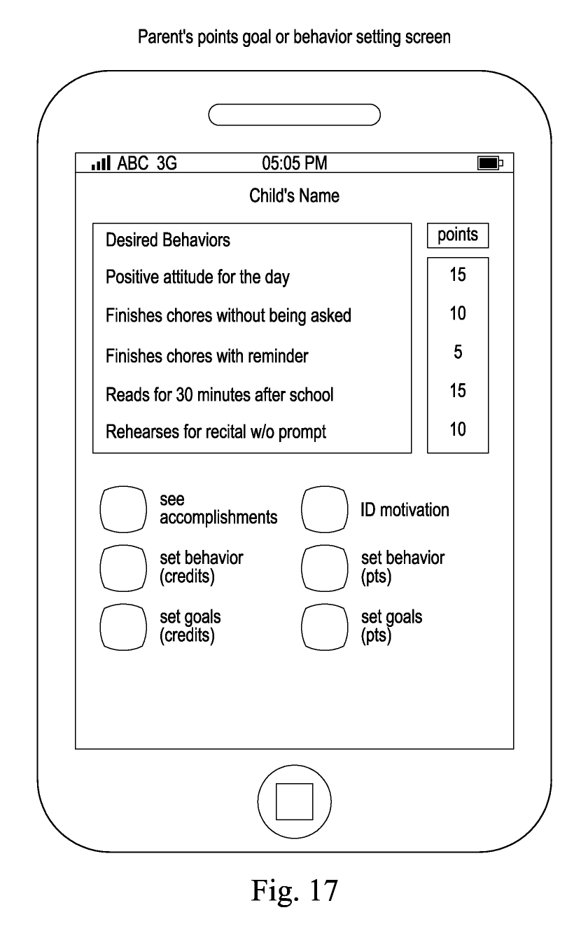

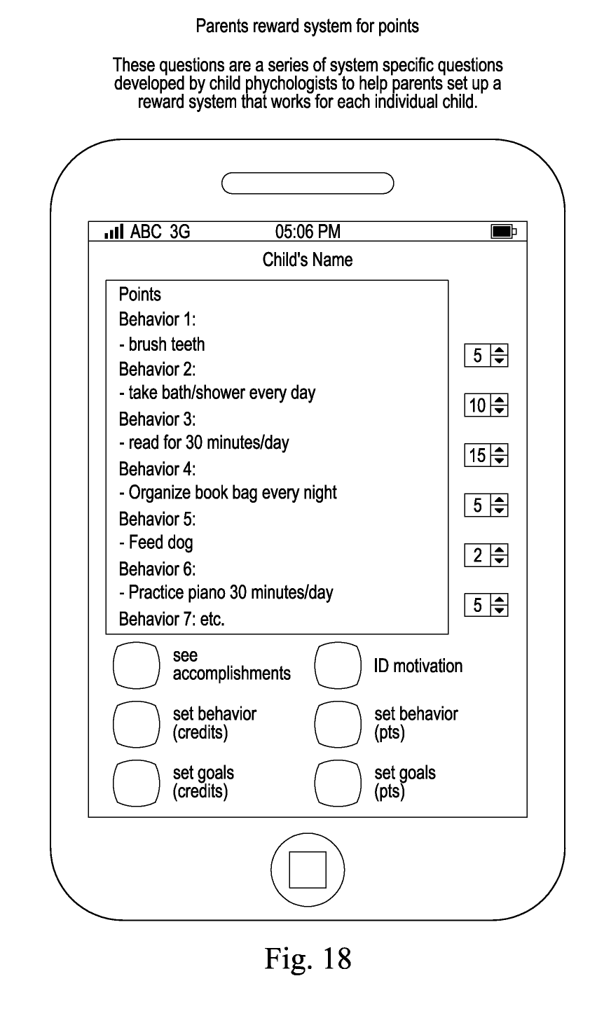

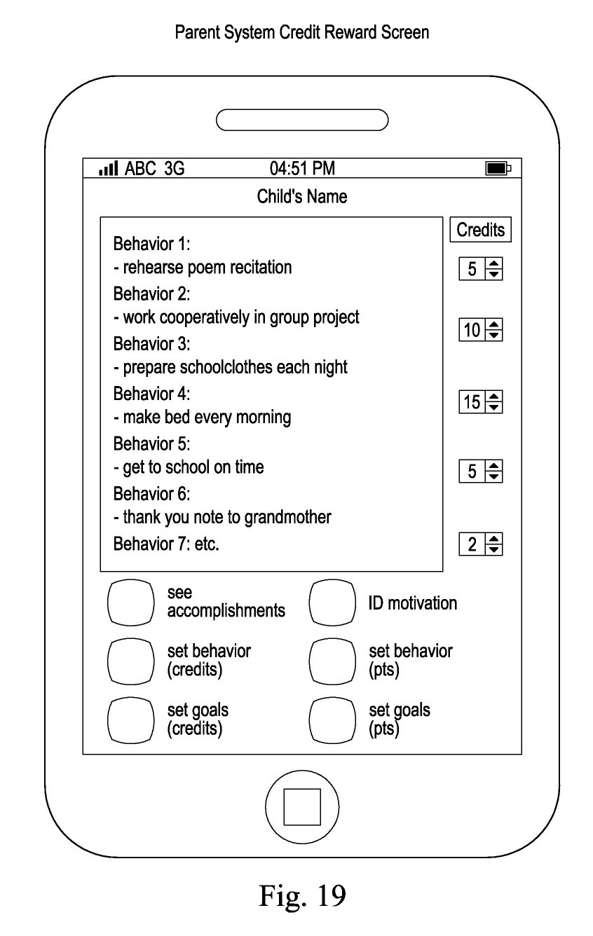

FIG. 15 illustrates an exemplary system screen for opening the assisting user's reward system. As illustrated, this opening screen displays information concerning the status of either system credits (i.e., system currency for buying items) or points, icons to go to various settings for behavior and goals, a motivation screen, accomplished goals/behaviors, and a calculation for determining either credits or points needed for different types of rewards to be awarded. Examples for the reward screens used for setting or viewing either credits or points for various goals or behaviors may be seen in FIGS. 16-19, as merely a few examples.

The system may be configured to support one or more types of rewards. In an aspect, two types of rewards may be issued: In-system Rewards and Out-system Rewards. In-system rewards are virtual and exclusive to system (i.e., issued within system and redeemed only in system) whereas Out-system rewards, although set up and monitored within system, are based on behaviors external to system (e.g., completing house chores, walking the dog, etc.) and are redeemed outside system (e.g., trip to the zoo, $5, extra hour of computer time, etc.). Assisting users are given options for setting up all Out-system rewards. Additionally, the system administers an internal reward system based on system credits, which may be configured to act and look like a currency. Targeted users accumulate system credits in their bank accounts. Just as in real live, the currency will be continually monitored to avoid inflation and exchanges for goods will be realistic.

The system Application reward system may be configured as a multi-level system. In such a system, targeted users must master some skills before advancing to the next level of rewards. The value of reward is contingent on usage and accomplishment. Targeted users automatically receive system credits when they take specific action or complete assignments on a timely basis. When a targeted user's accumulated number of system credits earned reaches the threshold of the next level, the targeted user automatically advances to the next level. With each level of advancement, rewards are given less frequently for previously rewarded actions and new methods of achieving rewards are introduced.

Once a targeted user advances to the next level, assisting users are notified and a congratulation message is automatically sent to the targeted user. If during the first two weeks at the new level, the targeted user fails to earn 50% of the average number of dollars earned during the last thirty days at the previous level, the targeted user is returned to the prior level. If the targeted user is returned to the previous letter, an encouragement or motivational message is sent to the targeted user along with a report on the first two weeks' transactions, indicating how the targeted user might improve.

According to a particular aspect, the reward system may include five levels of rewards. In a first exemplary “LEVEL ONE”, currency rewards of system Credits are issued with each targeted user interaction and are earned by a targeted user doing one or more of the following tasks or operations: Setting up Targeted user Profile; Setting up School Profile; Setting up Assisting user Profile; Creating a task list; Reviewing or entering assignments; Completing assignment on time; Completing all 3 profiles (i.e., school, targeted user, and assisting user); Reaching n$ amount of rewards; Completing x# of assignments on time; Completing a long term project with multiple tasks on time; consistent daily entries on school days (e.g., adding assignments, reviewing assignments, changing assignment status to complete, etc.) for set number of days, weeks, months, etc. In another aspect, a targeted user advances to a next level (i.e., “LEVEL TWO”) when targeted user's accumulated number of Credit earned is equal to some predetermined amount.

In an example, a next “LEVEL TWO” provides continued earning of currency rewards of system credits. In addition, targeted users have the ability to personalize their calendar format and the ability to change their system personal theme. In an example, rewards may be earned in any the following exemplary ways: completing assignments on time; using the application on weekend days; after reaching n$ amount of rewards; completing x# of assignments on time; completing a long term project with multiple tasks where both tasks and project were completed on schedule; consistently making daily entries on school days (e.g., adding assignments, reviewing assignments, changing assignment status to complete, etc.) for a set time period or recurring periods of time, and so forth. The system then may be configured to allow a targeted user to advance to a next level (i.e., “LEVEL THREE”) when the targeted user's accumulated number of dollars earned is equal to a second predetermined amount.

In an example, a next reward “LEVEL THREE” provides continued earning of currency rewards of system credits. Targeted users continue to have the ability to personalize their calendar format and change their system personal theme. In a further aspect, the system may be configured to allow targeted users to earn the right to set the sound of their transactions and the ability to add a personal theme song. Rewards are earned in the following ways: completing assignments on time; using the application on weekend days; reaching n$ amount of rewards; completing x# of assignments on time; completing a long term project with multiple tasks where both tasks and project were completed on schedule; completing a task within a project early; completing a project early (i.e., day+prior to the due date); consistently making daily entries on school days (e.g., adding assignments, reviewing assignments, changing assignment status to complete, etc.) for a set time period or recurring periods of time, and so forth; or admitting that an assignment is late (introduction of an “honesty concept reward”). If the due date is changed after the original due date and the targeted user identified “other ” as the reason, the targeted user gets an additional bonus for honesty. Furthermore, the system may be configured to allow a targeted user to demonstrate honesty through responses to scenarios with multiple choices, with varying levels of reward based on the qualitative response (e.g., poorer to better to best responses for a given scenario). These scenarios may be visualized with a system character, as another example. A targeted user may advance to a next level (e.g., “LEVEL FOUR”) when the targeted user's accumulated number of dollars earned equals a third predetermined amount.

In an example, a next reward level “LEVEL FOUR” may be configured to allow the system to provide continued earning of currency rewards of system credits. Targeted users also continue to have the ability to personalize their calendar format, to change their system personal theme, to set the sound of their transactions, and to add a personal theme song. Furthermore, in an example rewards for completed assignments are earned in one or more of the following ways: making updates or changes on weekend days; reaching n$ amount of rewards; completing x# of assignments on time; completing a long term project with multiple tasks where both tasks and project were completed on schedule; completing a task early within a project; completing a project early (i.e., day+prior to the due date); consistent making of daily entries on school days (e.g., adding assignments, reviewing assignments, changing assignment status to complete, etc.) for over a set time period(s) or successive periodic time periods; admitting that an assignment is late and, if the due date is changed after the original due date and the targeted user identified an unjustified and inexcusable reason such as “just because”, for example, the targeted user gets an additional bonus for honesty. Additional scenarios for demonstrating the attribute of charity may be provided at this level with multiple-choice responses. Furthermore, when Avatar related items are replaced, the system may be configured to prompt a targeted user if he/she would like to donate the old item to charity. In another example, at every nth purchase, the targeted user could be prompted whether she/he would like to donate system credit currency or actual funds to charity. A targeted user may advance to a next level (e.g., “LEVEL FIVE”) when the targeted user's accumulated number of dollars earned equals a fourth predetermined amount.

In an example, a next reward level “LEVEL FIVE” may be configured to allow the system to provide continued earning of currency rewards of system credits. Targeted users also continue to have the ability to personalize their calendar format, to change their system personal theme, to set the sound of their transactions, and to add a personal theme song. In addition, avatars are allowed to go “on vacation.” Rewards in this level may be earned according to one or more of the following ways: completing assignments on time; using the application on weekend days, reaching n$ amount of rewards; completing x# of assignments on time; completing a long term project with multiple tasks where both tasks and project were completed on schedule; completing a task early within a project; completing a project early (i.e., day+prior to the due date); consistent making of daily entries on school days (e.g., adding assignments, reviewing assignments, changing assignment status to complete, etc.) for over a set time period(s) or successive periodic time periods, admitting that an assignment is late and, if the due date is changed after the original due date and the targeted user identified an unjustified and inexcusable reason such as “just because”, for example, the targeted user gets an additional bonus for honesty, demonstrating charity, and so forth. Furthermore, LEVEL FIVE rewards may provide the targeted user to demonstrate integrity through responses to scenarios with multiple choices.

Assisting users and trusted third parties with the right credentials have the capability to create multiple types of system credit rewards for their targeted user and determine when the award is to be given. Rewards may be issued at a future event (i.e., scheduled through the system backend for automatic delivery in the future) or issued instantly (i.e., immediately delivered at the next synch). An assisting user might give an instant reward to a targeted user for extraordinary behavior at home or in a particular situation or set up a future reward to be delivered when the targeted user completes a particularly hard task or finishes a tough project. Assisting users may also choose to redeem targeted user's accumulated system credits outside of the system (i.e., x system credits equal a trip to the zoo, etc.).

The system may also afford assisting users the ability to create rewards contingent on an activity date. Examples of times when assisting users might want to set-up such rewards would be as follow: when a multi-task project is completed, “x” number of consecutive days of all assignments being completed by the due date, “x” number of consecutive days of homework (excludes multi-day assignments) being completed by the due date; when a project management task is completed early; when a project is completed early; when targeted user needs encouragement (unscheduled); the targeted user did something extraordinary at home (unscheduled); or the targeted user advances to the next level of efficiency and organization. The types of rewards that assisting user can issue in the system may include the following: system currency; system congratulations messages; or new music or video files, as just a few examples.

Out-system Rewards are created by assisting users to promote desired behaviors or issue rewards for behaviors that are not included in the system application but rather tied to goals and accomplishments in the physical world. Examples of Out-system goals could be keeping the targeted user's room clean, successfully performing at a recital, etc., and so forth.

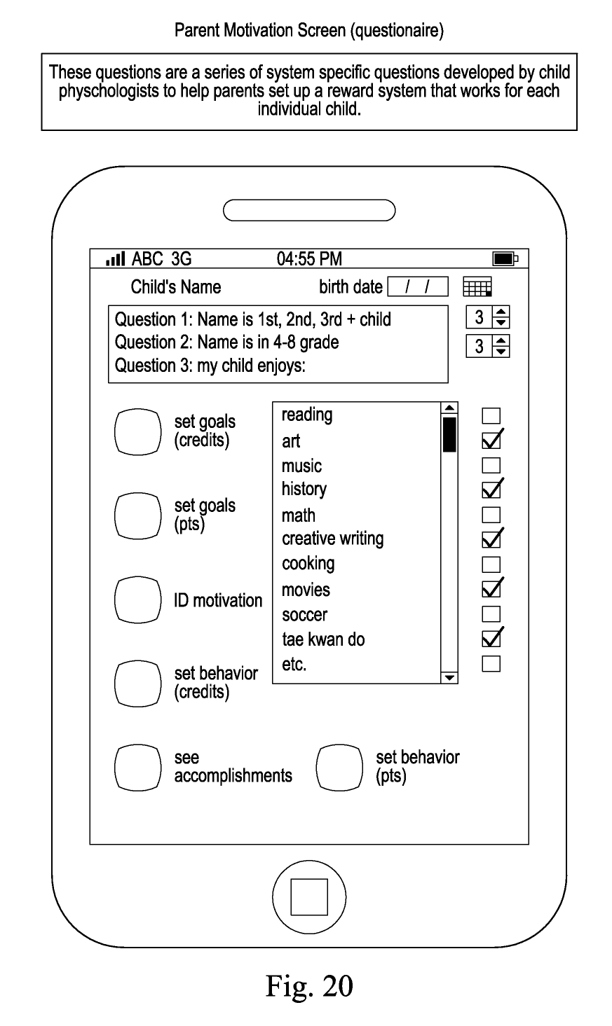

The system may include guided templates as illustrated in FIGS. 15-19 allowing assisting users to set-up, track and monitor their desired behavior change for their targeted user based on what motivates their targeted user. Furthermore, the system may include a system motivation functionality or tool that provides help to assisting users to understanding what motivates their targeted user based on the stored history of the targeted user. This system motivation tool helps assisting users identify what rewards really motivate their targeted user, thus enabling assisting users to structure more effective reward systems. As an example, FIG. 20 illustrates an exemplary motivation questionnaire screen that may be used for assisting the assisting user in setting up rewards through a series of questions and selections.

Assisting users are provided with a template of behaviors for which targeted users are typically rewarded, and which may include one or more of the following: practicing truthfulness, maintaining a pleasant and helpful attitude—thinking before you speak or act; practicing good manners, Treating others as you want to be treated, Refraining from shouting, yelling, or hitting, Avoid fighting with siblings, Treating all with respect, including siblings, assisting users and pets, Being responsible—doing what you say and say what you'll do, Maintaining appropriate school grades (e.g., all As, Bs and above, Cs and above, etc.), keeping a tidy room, picking up after him/herself, and being respectful of others, as merely a few examples.

The presently disclosed system also provides means to track the behaviors on a daily basis and aggregate reward points per day, week, month, or year. Every time assisting users wishes to reward their targeted user, the assisting users simply select the “Add Reward” icon upon which occurrence the assisting user may select the reward and value to be given. As described before, assisting users will be able to customize a unique reward system for each targeted user (See FIGS. 16-20). Multiple template types targeting different behavior changes will be provided. Assisting users are encouraged to use both reward systems to obtain desired behavior or behavioral change in their targeted users.

The presently disclosed system may also be integrated to schools to support school-based reward systems (i.e., established for an entire school), which would enable assisting users and schools to support the same behaviors at home as at school and vice versa should the school agree to do the same. In an aspect, school staff would have access to system templates, which they could customize for the school. The system affords input from schools toward behaviors oriented toward tasks, grades, and citizenship, as examples. Specific examples include homework submission, grades on homework, quizzes, and tests, serving others and minimizing interruptions in the classroom. The school reward system would also include the ability to subtract points or reduce accumulated current balances for such behaviors as tardiness in arriving to class, cheating, attitude, etc.

System credits can be used to purchase virtual goods and services for the targeted user's avatar or friends' avatars. These purchases can be made from the smart device or from a web-based system social network for Creativity collaboration (termed herein “Creativity Network”). Purchases may be cosmetic (i.e., appearance altering), fashion-oriented, trip oriented, life enriching or simply frivolous. Services may also be purchased. The following is a list of possible system credit purchases: Cosmetic changes including the following: Hair Eye, Nose, Mouth, Ears, Weight, Physique; Fashion oriented, such as Scarves/ties, Belt, Clothes, Shoes; Trip oriented such as practical clothes for the journey (i.e., climbing Mt Everest), Tools Transportation; Life enriching such as Pets; Frivolous, such as Car, Jewelry; and Gifts that can be sent to other avatars such as flowers, greeting card system credits, candy-grams.

In still a further aspect, the system may also include a Health Management application that is used to teach healthy lifestyle skills to targeted users. This module may include relevant food information (calorie counts), school lunch menus with a recommended eating plan, journal of what the targeted user eats and how much exercise the targeted user did throughout the day. The product will be integrated with small monitors that the targeted user wears throughout the day. This data will be captured in the system application and available to assisting users and health care providers.

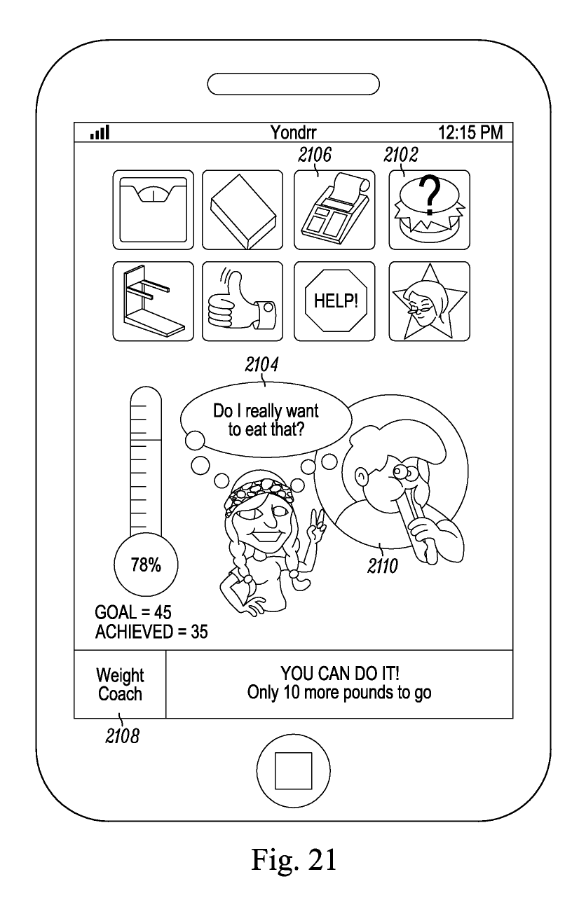

The system application may also be configured to assist targeted users to track food and exercise using a pictorial that helps them better matches the exercise being done to the food being eaten. It will help kids make good food choices, help them stay focused on weight and exercise goals, monitor accomplishments and coach them. For example, in a scenario illustrated in the screen shot of FIG. 21, a targeted user has asked for help. She is trying to decide whether she is hungry and whether she should eat a particular item. As may be seen in FIG. 21, the system allows nutritional information through an icon 2102. Additionally, the system application may issue encouraging prompts such as 2104 to encourage toward different food choices. Still further, accountability and costs may be displayed (See icon 2106), and a “weight coach” message 2108 provides positive encourage to work toward particular health goals. The health management application will also use include a built in reward system, structured to promote healthy eating, making good food and exercise choices and going to the coach for assistance. In the case where the targeted user is on a weight reduction program, the application will keep track of the pounds lost and issue small rewards for every pound lost. The rewards will get larger as the weight loss increments increase (i.e., every 5 pounds, every 10 pounds, every 25 pounds, etc.) and each advancement brings a greater reward. It is noted that the screen in FIG. 21 may also include other graphics or visuals to indicate that certain choices are either beneficial or not, or to provide other motivations for particular choices. As merely one example, an visual with a child overeating with big cheeks is illustrated at 2110.

In yet a further aspect, the system may provide networking (i.e., the “Creativity

Network”) for either Creativity solo or collaborative efforts. This may be web based and use wilds and other Web 2.0 tools (or later developed technology tools) to promote learning and personal improvement for targeted users, but also could be implemented in a mobile application as well. This network may be implemented through server 103, or in a cloud based network. This functionality of a Creativity Network enables targeted users to focus on their strengths and interests by encouraging them to write books, stories, and poems; create art; compose music and songs; develop and document science and math projects; envision new fashions and architecture; invent games; and write about diverse cultures. It connects targeted users of similar ages with similar interests which fosters collaboration on Creativity efforts and fosters friendships for those who may be otherwise challenged in connecting with other targeted users (due to ADD/ADHD, weight, appearance, Asperger's, etc.)

The Creativity Network can be configured to host multiple discussion topics in the creativity categories (e.g., books, art, music, etc.) on such topics as how to write a book, great ideas for poetry, penning catchy lyrics for songs, etc. The network focuses on the same ages as the system Application (targeted users ages 8-17) and uses the same reward system as the system Application. Targeted users communicate to one another through avatars, which are established in the same process as on the system Application. Avatars can be created in either in the system Application or on the system Creativity Network. The same avatar serves both applications.

The system may be further configured to allow each targeted user to have a public and private “studio.” Private studios are working studios where collaboration takes place. Private studios are entered by others through invitation only. Public studios are like art galleries where both private showings and public showings may take place. Private showing require an invitation as well.

The network also supports publishing services that walks assisting users and targeted users through the A to Zs of writing a book—from concept to publication and copyright. Standard templates are available to design, upload, and publish utilizing tiered approaches ranging from basic to intermediate to advanced features publishing both electronic and paperback books. In the future, system will consider publishing music and more gaming.

Targeted users or assisting users use the same credentials on for both the system Application and the Creativity Network but are required to add additional information to their existing profiles for the Creativity Network.

When targeted users log on to the Creativity Network for the first time, they are asked to provide their areas of interest: prose writing, poetry, music, video & movie reviews, science, math, history, reading & book reviews, cooking, art, and travel. Targeted users interested in travel can express interest in getting a pen pal and specify the gender and geographical area for the pen pal. Targeted users can also express social interest and whether they hope to make friends who are similar to them (i.e., other writers), complimentary to them (i.e., artists who may eventually provide graphics for the targeted user interested in writing) or someone totally different allowing the targeted user to select the category of interest for the person they hope to befriend—selecting from the areas of interest previously mentioned. They also identify their favorite music (e.g., rock, disco, doo wop, hip hop, Latin, new wave, blues, classical, country, folk, jazz, new age, rhythm & blues, soul, rap, reggae, etc.).

When assisting users log on to the Creativity network for the first time, they are asked to validate their targeted user(s)'s age(s). If the targeted user is under the age of 13, the assisting user must approve all individuals wanting to join their targeted user's inner circle (i.e., have access to the targeted user's private studio). If the targeted user is over the age of 13, the assisting user has the option to approve individuals wanting to enter their targeted user(s)'s private studio. Assisting users select the medium they want to use for being notified about pending RSVP responses as well as the medium they use to communicate back to their targeted user. Individuals with pending RSVPs are notified in the same medium used to invite them. In-system messaging board(s), text, and email are supported mediums. The system may include icons, short cuts or other methods to make adding this new information as seamless and interesting as possible.

Targeted users use their private studio to create. Works may be loaded into the Creativity Network or targeted users may collaborate and communicate among themselves in their private studios. Studios are private and targeted users must be granted access by the owner of the studio. A targeted user's avatar may invite other targeted users' avatars to her personal studios or other targeted users' avatar may request entry to another targeted user's studio.

Targeted users who post work in their private studio may invite select individuals to view it. Invitations are issued by email, text or via the web site (to others who have system credentials). Upon an individual's acceptance of an invitation, assisting users are notified. Upon assisting user approval (for targeted users under the ages of 13), the invitee is granted access to the private studio hosting the work. In the event the invitee does not have system credentials, the invitee will need to create a system guest ID (i.e., name, email, phone, city, state, relationship to the artist, age, purpose of communicating with the targeted user, etc.)

Targeted users who post work in their public studio may send announcements to those with system credentials thought the system network or notifications to others via text and email. Any recipient of the announcement with system credentials may send a congratulatory response to the targeted user. Congratulatory responses can be virtual—flowers, balloons, charitable donation in their honor or gifts for the avatar (from the previously mentioned lists of items available for purchase). In an aspect, the system may also be configured to provide or offer fee-based gifts such as flowers, balloons, and ecard. The targeted user also has the option to invite those with system credentials with similar interest. Invitees to public showings will not be required to obtain system credentials to see the show. However, they will require system credentials to communicate with the targeted user. Again, this will require assisting user approval and the invitee creating a system guest ID as described above.

The example in FIG. 8 illustrates one example in either a web based user screen or mobile device user screen with icon links 906 to the Creativity Network. Targeted users may be allowed to design their space (i.e., select their 4 borders from a template of designs, select a pet (optional) and name their pet (optional). The web page will reflect their weekly calendar 904 from the system Application as well as access to other Application features (i.e., their bank account 910, goals 912, the system store 914). It will serve as a gateway to collaboration for original writing, art, music, and recipes as well as to “ask the expert” who serves as a type of Ann Landers or Miss Manners for tweens and teens and “ask the peer” who also serves as a younger version of Ann Landers or Miss Manners.

Targeted users are rewarded for doing the following: publishing new items in their private studios, publishing new items in their public studios, issuing invitations to collaborate with others, publishing a book, etc. In addition to the rewards previously described for the system Application, targeted users using the Creativity Network also get music snippets from their favorite category of music selected.

Assisting users interested in publishing their targeted user's book are walked through a series of questions for book publication. The following information is needed: book title, book author, illustrator (if applicable), photographer (if applicable), and whether the book can be downloaded in pdf format. The assisting user may then be afforded selection of one or more of the following: book type, about the covers, about the chapters in the book, illustrations, art work, photographs, and so forth for publishing of the book. The assisting user is advised that if all art work is not present that system will notify the assisting user and the assisting user will have the option of submitting the missing art work or changing the template to accommodate the material actually submitted. The assisting user is also reminded that system objective is to build self-esteem and self-confidence in targeted users, therefore the system does not publish any works without light editing.

In addition to the above, the Creativity Network may also be configured to allow networking of constructive critique to improve future writing, find stock photos., providing marketing strategies.

In light of foregoing, it will be appreciated that the presently disclosed system supports assisting users as they seek behavior changes in their targeted users and solutions to their problems with their targeted users. As discussed before, the system also enables communities of like-minded assisting users with similar problems with their targeted user(s) to connect and learn from each other as well as connect to subject matter experts. The system may include functionalities to feature articles from assisting users and experts to help assisting users in raising their targeted users.

Concerning system security, in an aspect all targeted user personal data is accessible only by the targeted user or the targeted user's assisting users (e.g., calendar, contacts, photos, objectives, etc.). In the event an assisting user establishes an assisting user-based reward system for the targeted user, the criteria pertains to a specific targeted user and is only accessible by the assisting user(s) and trusted third parties allowed by the administrator. Furthermore, the system Creativity Network will be hosted in a secure, trusted environment that will be monitored by experts in targeted user behavior. As the system community increases, monitoring will become automated. Business rules require assisting user authorization for targeted users under age 13 to submit and post work publically. The current submission process generates an email to a targeted user's assisting user that requests permission to post their targeted user's work. Moreover, the system in configured to accommodate business rules requiring assisting user consent for targeted users under the age of 13 to allow someone into their private or public studio when an event is by invitation only. No one can communicate with any targeted user under the age of 13 without assisting user consent. Assisting users have the option to use this feature for targeted users over the age of 13 as well.

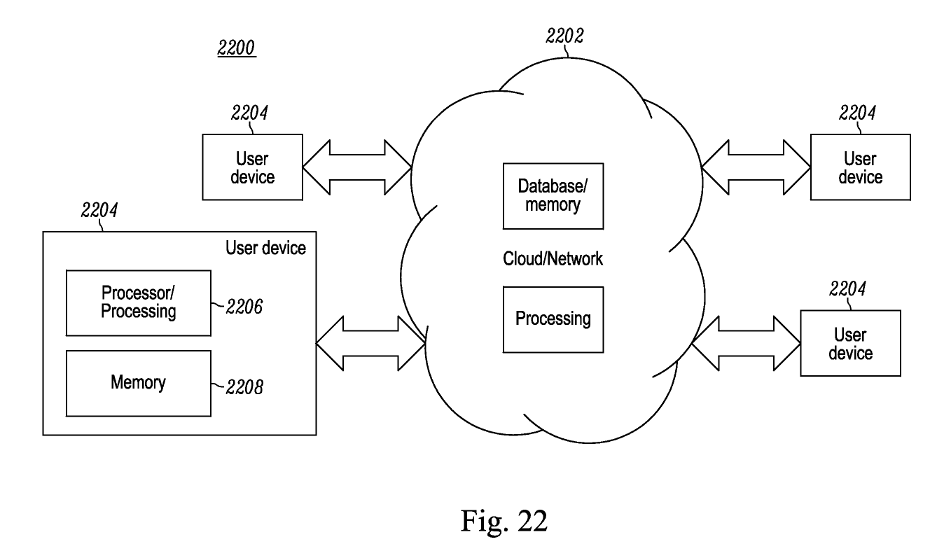

FIG. 22 another exemplary diagram of an apparatus 2100 for implementing a system for effecting behavior modification. The apparatus includes a cloud or network 2102 containing processing and memory/database functionality for performing system functions, such as those discussed above. The memory may contain instructions or code for causing the processing functions (e.g., one or more computers) to implement a network allowing user devices 2104 to communicate and provide functionalities to the user devices.

Additionally, each of the user devices 2104 includes processing 2106 and memory 2108 functionality, including functions to connect to the network 2102 via one or more technologies and one or more applications or functions configured to assist a first targeted user using the user device in human behavior modification. Furthermore, some of the devices 2104 may be configured for assisting users or other users to assist those users of targeted devices 2104 in behavior modification.

Other contemplated functionalities may include allowing assisting users, such as a teacher, to access a group (e.g., a class) and determine which targeted users have not completed tasks, assignments, etc., or contemplated tasks in an unsatisfactory or not in timely manner. Additionally, the assisting user may then cause a message or communication to be issued through the system to other assisting users (e.g., parents or guardians) notifying of uncompleted or unsatisfactorily completed tasks.

Yet further, other functionalities may include stand-alone functionalities where targeted users are connected to the system, but not networked with some or all assisting users (e.g., parents or guardians).

The word “exemplary” is used herein to mean “serving as an example, instance, or illustration.” Any embodiment or example described herein as “exemplary” is not necessarily to be construed as preferred or advantageous over other embodiments.

It is understood that the specific order or hierarchy of steps in the processes disclosed is merely an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of tangible computer-readable storage medium known in the art. An exemplary tangible storage medium is coupled to the processor such the processor can read information from, and write information to, the storage medium. In the alternative, the tangible storage medium may be integral to the processor. The processor and the storage medium may reside in an integrated circuit or multiple circuits. Furthermore, the integrated circuits effecting functions of the software may reside in a user terminal or device, and/or in one or more central servers. Furthermore, the term “computer” as used herein may include any computational device, such as personal computers, mobile devices, tablets, and the like, or processors or processing subsystems within such devices.

The above description of the disclosed examples and aspects is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for providing human behavior modification solutions to at least one user, the apparatus comprising:
a network allowing one or more user devices to communicate and provide functionalities to the one or more user devices; and
at least one first user device configured to connect to a network, the user device configured to include one or more applications or functions configured to assist at least a first targeted user using the at least one first user device for human behavior modification.

2. The apparatus as defined in claim 1, further comprising at least one second user device configured to connect to the network, the at least one second user device configured to include one or more applications or functions configured to at least provide at least a second assisting user functionality to provide assistance to the at least a first targeted user using the at least one first user device in human behavior modification.

3. The apparatus as defined in claim 1, further comprising:
the at least one first user device configured to allow user personalization of the one or more applications or functions.

4. The apparatus as defined in claim 2, further comprising:
the at least one second user device configured to allow user personalization of the one or more applications or functions.

5. The apparatus as defined in claim 1, wherein the at least one user device and the network are further configured to provide one or more of social network connectivity, collaborative network connectivity, reward systems, scheduling information and reminders, task information, task scheduling and organizing, communication messages from at least one of network functions and a second user device in the network, learning/teaching functions, and game/entertainment functions.

6. The apparatus as defined in claim 2, wherein the at least one second device and the network are further configured to provide one or more of social network connectivity, collaborative network connectivity, reward systems, scheduling information and reminders, task information, task scheduling and organizing, communication messages from at least one of network functions and a second user device in the network, learning/teaching functions, and game/entertainment functions.

7. The apparatus as defined in claim 1, wherein the one or more applications or functions include communicating via at least the at least one first user device:
rewards to the first targeted user;
gaming and entertainment functions on the at least one first user device;
visualization of scheduling and reminder information, task information, task scheduling and organization information, and communication messages on the at least one first user device;
and cause and effect functions and visualizations on the at least one first user device configured to teach the targeted user academic, executive function, and social skills.

8. The apparatus as defined in claim 1, wherein the one or more applications or functions include providing a graphic user interface including characters or avatars to interact with other user devices, functionalities residing in the network, or other functionalities effected in at least one first user device.

9. The apparatus as defined in claim 1, wherein the one or more application or functions are configured to effect behavior modification in one or more of organization/time management behavior, social skill behavior, character/social graces/etiquette behavior, physical fitness/health/weight, financial/buying behavior, and confidence/self-esteem.

10. The apparatus as defined in claim 2, wherein the one or more application or functions allow the second assisting user to issue with the at least one second user device at least one of user-defined rewards to the first targeted user and communication messages to the first targeted user via the at least one first user device.

11. A computer program product, comprising:
computer-readable medium comprising:
code for causing a computer to implement a network allowing user devices to communicate and provide functionalities to the user devices; and
code for causing a computer to provide at least one first user device a functionality to connect to the network and one or more applications or functions configured to assist at least a first targeted user using the at least one first user device in human behavior modification.

12. The computer program product as defined in claim 11, the computer-readable medium including code for causing a computer to provide at least one second user device a functionality to connect to the network, and one or more applications or functions configured to at least provide a second assisting user functionality to provide assistance to the first targeted user using the at least one first user device in human behavior modification.

13. The computer program product as defined in claim 11, further comprising:
code configured to allow user personalization of the one or more applications or functions for the at least one first user device.

14. The computer program product as defined in claim 12, further comprising:
code configured to allow user personalization of the one or more applications or functions for the at least one second user device.

15. The computer program product as defined in claim 11, further comprising code for causing at least one computer to provide the at least one first user device and network one or more of social network connectivity, collaborative network connectivity, reward systems, scheduling information and reminders, task information, task scheduling and organizing, communication messages from at least one other first or second user device in the network, learning/teaching functions, and game/entertainment functions.

16. The computer program product as defined in claim 11, further comprising code for causing at least one computer to provide one or more applications or functions to include communication via at least the at least one first user device:
rewards to the first targeted user;
gaming and entertainment functions on the first user device;
visualization of scheduling and reminder information, task information, task scheduling and organization information, and communication messages;
and cause and effect functions and visualizations configured to teach the targeted user academic, executive function, and social skills.

17. The computer program product as defined in claim 11, wherein the one or more applications or functions include providing a graphic user interface including characters or avatars to interact with other user devices, functionalities residing in the network, or other functionalities effected in at least one first user device.

18. The computer program product as defined in claim 11, wherein the one or more application or functions are configured to effect behavior modification in one or more of organization/time management behavior, social skill behavior, character/social graces/etiquette behavior, physical fitness/health/weight, financial/buying behavior, and confidence/self-esteem.

19. The computer program product as defined in claim 12, wherein the one or more application or functions allow the second assisting user to issue with at the least one second user device at least one of user-defined rewards and communication messages to the first targeted user via the at least one first user device.

20. A method for providing human behavior modification solutions for at least one user of system for human behavior modification, the method comprising:
providing a network allowing user devices to communicate and provide functionalities to the user devices; and
providing functionality to at least a first user device including functionality to connect to the network, the first user device configured to include one or more applications or functions configured to assist a first targeted user using the at least one first user device in human behavior modification.

21. The method as defined in claim 20, further comprising:
providing at least one second user device with functionality to connect to the network, the at least one second user device configured to include one or more applications configured to at least provide a second assisting user functionality to provide assistance to at least a first targeted user using the at least a first user device in human behavior modification.

22. The method as defined in claim 20, further comprising:
the first user device configured to allow user personalization of the one or more applications or functions.

23. The method as defined in claim 21, further comprising:
the second user device configured to allow user personalization of the one or more applications or functions.

24. The method as defined in claim 20, further comprising providing the at least one first user device social network connectivity, collaborative network connectivity, reward systems, scheduling information and reminders, task information, task scheduling and organizing, communication messages from at least one other first or second user device in the network, learning/teaching functions, and game/entertainment functions.

25. The method as defined in claim 20, further comprising providing the one or more applications or functions for communicating via at least the first user device:
rewards to the first targeted user;
gaming and entertainment functions on the first user device;
visualization of scheduling and reminder information, task information, task scheduling and organization information, and communication messages;
and cause and effect functions and visualizations configured to teach the targeted user academic, executive function, and social skills.

26. The method as defined in claim 20, wherein the one or more applications or functions include providing a graphic user interface including characters or avatars to interact with other user devices, functionalities residing in the network, or other functionalities effected in the at least one first user device.

27. The method as defined in claim 20, wherein the one or more application or functions are configured to effect behavior modification in one or more of organization/time management behavior, social skill behavior, character/social graces/etiquette behavior, physical fitness/health/weight, financial/buying behavior, and confidence/self-esteem.

28. The method as defined in claim 21, wherein the one or more application or functions allow the second assisting user to issue with the at least one second user device at least one of user-defined rewards to the first targeted user and communication messages to the first targeted user via the at least one first user device.
